(19) United States
(12) Patent Application Publication
(10) Pub. No.: US 2015/0065644 A1
(43) Pub. Date: Mar. 5, 2015

(54) PARTICLES FOR ELECTROWETTING DISPLAYS

(71) Applicant: Merck Patent GmbH, Darmstadt (DE)

(72) Inventors: Louise D. Farrand, Dorset (GB); Nathan Smith, Southampton (GB); Roshan Kumar, Bracknell (GB); Claire Topping, Southampton (GB)

(73) Assignee: Merck Patent GmbH, Darmstadt (DE)

(21) Appl. No.: 14/387,036

(22) PCT Filed: Feb. 25, 2013
(86) PCT No.: PCT/EP2013/000539

§ 371 Date: Sep. 22, 2014

(30) Foreign Application Priority Data
Mar. 23, 2012 (EP) 12002083.9

(51) Int. Cl. G02B 26/00; C08F 220/36; C08L 33/14

(52) U.S. Cl. CPC G02B 26/005; C08L 33/14; C08F 220/36; C08L 2203/20
USPC 524/555; 526/312

(57) ABSTRACT

This invention relates to polymer particles for use in electrowetting fluids and electrowetting displays devices comprising such particles.

This invention relates to polymer particles, a process for their preparation, the use of these particles for the preparation of an electrowetting device, and electrowetting displays comprising such particles.

Electrowetting displays (EWD) offer a new route to e-paper that combines video rate response times with a reflective colour display that can be read in bright sunlight, and show low power consumption relative to a typical LCD display. Electrowetting (ew) is a physical process where the wetting properties of a liquid droplet are modified by the presence of an electric field. This effect can be used to manipulate the position of a coloured fluid within a pixel. For example, a nonpolar (hydrophobic) solvent containing colourant can be mixed with a clear colourless polar solvent (hydrophilic), and when the resultant biphasic mixture is placed on a suitable electrowetting surface, for example a highly hydrophobic dielectric layer, an optical effect can be achieved. When the sample is at rest, the coloured non-polar phase will wet the hydrophobic surface, and spread across the pixel. To the observer, the pixel would appear coloured. When a voltage is applied, the hydrophobicity of the surface alters, and the surface interactions between the polar phase and the dielectric layer are no longer unfavourable. The polar phase wets the surface, and the coloured non-polar phase is thus driven to a contracted state, for example in one corner of the pixel. To the observer, the pixel would now appear transparent. The invention of electrowetting fast switching displays was reported in Nature (R. A. Hayes, B. J. Feenstra, Nature 425, 383 (2003)). Electrowetting displays are also described in WO 2005/098524, WO 2010/031860, WO 2011/075720, WO 2010/104606, and WO2011/017446.

The colour properties of the nonpolar phase will be dictated by the chromophores present in the non-polar phase, and the cell architecture. Since the observed effect is based on surface interactions, there is an advantage to decreasing the cell gap as much as possible to maximise the effect of the surface on the material layer. Typically, if the material layer is too thick, the surface effects will be lessened, and higher voltages will be required to drive the display. However, thinner material layers provide a challenge with regards to achieving strong colour saturation, as the thinner the layer, the lower the absorption of the layer. For EWD, there is a requirement for a non-polar phase showing high colour intensity. Furthermore, there is a desire for electrowetting display materials with improved colour tuning, for example to match a company logo colour, to enhance colour gamut, or to improve contrast ratio. Therefore, the object of this invention is to provide new electrowetting display materials.

This object is solved by an electrowetting fluid according to claim 1, by the use of such electrowetting fluid for the preparation of an electrowetting display device and by an electrowetting display device comprising such electrowetting fluid.

The electrowetting fluid of the invention contains preferably a non-polar solvent or a mixture of non-polar solvents and polymer particles comprising monomer units of a) at least one polymerisable dye, b) at least one monomer, c) optionally at least one charged co-monomer, and d) optionally at least one crosslinking co-monomer.

In particular, the present invention concerns electrowetting fluids containing black polymer particles and preferably a non-polar solvent or a mixture of non-polar solvents.

This invention specifically relates to polymer particles that can be easily dispersed in non-polar media and they do not leach dye in a dispersant.

Therefore, the particles are explicitly useful for electrowetting fluids and displays.

Advantages of using dyed particles rather than just dyes on their own is that the dyes can be chemically bonded to the particle and thus will remain in the same phase as the particles. Using the dye on its own creates the potential for leaching into both phases, and this is undesirable. It is also likely that the photostability and hence lifetime of the display will be improved by incorporating the dye in the particle, rather than having free dye in solution.

Polymeric sub-micron sized particles suitable for use in the non-polar phase of EWD are preferably prepared in a simple 1-step reaction using polymerisable dyes with at least one polymerisable group. To provide the best possible colour fastness, the dye properties are chosen for the dye to both react with other monomers and to be preferentially soluble in the particle. Especially the use of a polymerisable dye with more than one polymerisable group enables the dye to become irreversibly chemically bound and well entangled in the polymer particle, thus avoiding any leaching into the EWD solvent. It reduces the amount of any solvent soluble unreacted dye and dye oligomers formed. Hence the dye is more likely to be polymerised into the forming particle than if just one polymerisable group is used, hence avoiding extensive washing to remove any unreacted dye and oligomers from the particles which could also leach from the particles over time. These polymerisable dyes are incorporated throughout the particles and not just at the shell giving a greater loading of dye into the particle. The particles are less likely to suffer from photo or oxidation degradation.

The present invention advantageously provides non-polar EWD fluids comprising polymer particles, especially black polymer particles, wherein the polymer particles can be prepared without additional steps, comprise a dye/dyes which does/do not leach into the EWD fluid, and possess the ability to achieve and easily adjust required shade. Particle size can be controlled, and mono-disperse particles can be prepared. The particles are prepared in a solvent suitable for the non-polar phase of EWD and do not require expensive freeze drying steps. Particles with a low density can be prepared to help avoid settling issues. Another advantage is the reduction of the amount of unreacted dye and therefore reduction of the amount of cleaning steps such as centrifugation followed by decantation. It is also possible to increase the loading of dye in a particle to achieve the desired depth of black. A further advantage is that the properties of the dye can be tailored to the particles so that the dye does not adversely affect the formation or properties of the particles.

An essential component of the present electrowetting fluids are polymer particles comprising monomer units of a) at least one polymerisable dye, b) at least one monomer, c) optionally at least one charged co-monomer, and d) optionally at least one crosslinking co-monomer.

The polymerisable dye comprises at least one, preferably two polymerisable groups. In general the polymerisable dyes may be solvent soluble or water soluble and they may be anionic, cationic, zwitterionic or neutral.

The function of the polymerisable dye is to colour the particle. The polymerisable dye consists of a chromophore, at least two polymerisable groups, optional linker groups (spacers), and optional groups to modify physical properties (like solubility, light fastness, etc.) and optionally charged group(s).

The polymerisable dye preferably comprises a chromophoric group and two polymerisable groups selected from e.g. methacrylates, acrylates, methacrylamides, acrylamides, acrylonitriles, α-substituted acrylates, styrenes and vinyl ethers, vinyl esters, propenyl ethers, oxetanes and epoxys etc., in particular methacrylates and acrylates.

A polymerisable dye may contain a single chromophore, for example with bright yellow, magenta or cyan colours and self shade blacks. However, it may also contain mixed covalently attached chromophores for example to obtain a black colour, by covalently attached brown and blue or yellow, magenta and cyan. Green can be obtained by yellow and cyan etc. Extended conjugated chromophores can also be used to obtain some shades. For example, bis- and trisazo compounds can be used to obtain blacks and other duller shades (navy blue, brown, olive green, etc).

Mixtures of polymerisable dyes can also be used to obtain the correct particle shade; for example a black from single component mixtures of brown and blue or yellow, magenta and cyan pre-polymerised dyes. Similarly shades can be tuned for example by adding small quantities of separate polymerisable dyes to modify the colour of the particles (e.g. 95% yellow and 5% cyan to get a greener yellow shade).

Modified polymerisable dyes (with reactive group(s)) from the application groups of reactive (anionic), direct (anionic), acidic (anionic) and basic (cationic) dyes as designated by the Colour Index (published by The Society of Dyers and Colourists with the American Association of Textile Chemists and Colorists e.g. 3^{rd} edition 1982) are preferred.

The polymerisable groups may be attached directly to the chromophoric group or may be attached through a linker group L.

The chromophoric group preferably comprises of conjugated aromatic (including heteroaromatic) and/or multiple bonds including: azo (including monoazo, bisazo, trisazo, linked azos etc), metallised azo, anthraquinone, pyrroline, phthalocyanine, polymethine, aryl-carbonium, triphendioxazine, diarylmethane, triarylmethane, anthraquinone, phthalocyanine, methine, polymethine, indoaniline, indophenol, stilbene, squarilium, aminoketone, xanthene, fluorone, acridene, quinolene, thiazole, azine, induline, nigrosine, oxazine, thiazine, indigoid, quinonioid, quinacridone, lactone, benzodifuranone, flavonol, chalone, polyene, chroman, nitro, naphtholactam, formazene or indolene group or a combination of two or more such groups.

Preferred polymerisable dyes are azo dyes, metallised dyes, anthraquinone dyes, phthalocyanine dyes, benzodifuranones dyes, Brilliant Blue derivatives, pyrroline dyes, squarilium dyes, triphendioxazine dyes or mixtures of these dyes, especially azo dyes, metallised dyes, anthraquinone dyes, phthalocyanine dyes, benzodifuranones dyes, pyrroline dyes, squarilium dyes or mixtures of these dyes.

Preferably, polymer particles described in WO 2010/089057, WO 2011/154103 and/or WO 2012/019704 may be used.

Especially, polymer particles comprising polymerisable dyes of Formula (1) are preferred

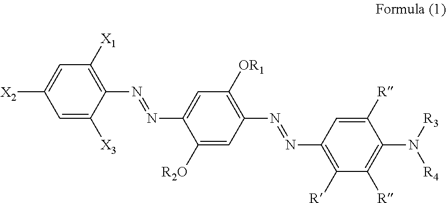

### Wherein

X₁, X₂, and X₃ are independently of one another H or an electron-withdrawing group;
R₁ and R₂ are independently of one another groups of the structure L₁-Y₁, L₂-Y₂ or linear, branched or cyclic alkyl groups;
R₃ and R₄ are independently of one another groups of the structure L₃-Y₃, L₄-Y₄ or linear, branched or cyclic, substituted or unsubstituted alkyl groups where one or more non-adjacent carbon atoms may be replaced by O, S and/or N, preferably O;
L₁, L₂, L₃, and L₄ are linker groups and independently of one another linear or branched, substituted or unsubstituted alkylene groups where one or more non-adjacent carbon atoms may be replaced by O, S and/or N, preferably O;
Y₁, Y₂, Y₃, and Y₄ are independently of one another polymerisable groups;
R′ is a linear or branched alkyl group, OR₅, H, NHCOR₆ or NHSO₂R₇;

### R″ is OR₅, H or NHCOR₆,

R₅, R₆, and R₇ are independently of one another linear or branched alkyl groups; and
Wherein at least one of R₁, R₂, R₃ and R₄ is a polymerisable group and at least one of X₁, X₂, and X₃ is an electron-withdrawing group.

Preferably black polymerisable dyes of Formula (1) are used to prepare black polymer particles for use in electrowetting devices. Preferably one black polymerisable dye is used. However, at least two polymerisable dyes of Formula (1) may be used for the preparation of black polymer particles. In a variant of the invention, at least one of the polymerisable dyes of Formula (1) is used in combination with at least one other polymerisable dye, e.g. those described in WO 2010/089057 and WO 2012/019704. Such combinations may be especially useful for the preparation of polymer particles which are of a neutral black colour. Optionally yellow polymerisable dyes like Dye A and Dye B or cyan polymerisable dyes like Dye C or magenta polymerisable dyes like Dye D may be used in combination with dyes of Formula (1).

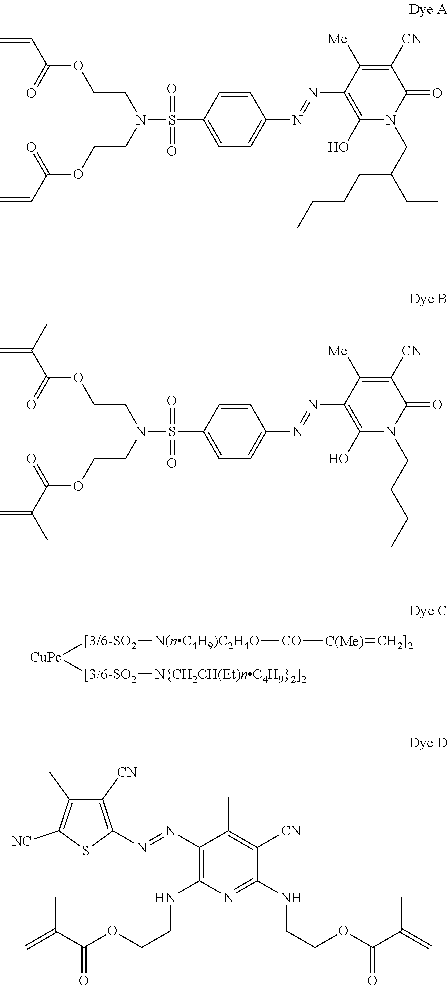

The term “electron-withdrawing group” is well known in the art and refers to the tendency of a substituent to attract valence electrons from neighbouring atoms; in other words the substituent is electronegative with respect to neighbouring atoms. Examples of electron-withdrawing groups include NO₂, CN, halogen, acyl, trifluoromethoxy, trifluoromethyl, SO₂F, and CO₂R, SO₂R, SO₂NRR or SO₂NHR, with R being independently linear or branched alkyl, preferably C1-C4 alkyl. Preferably, at least one of X₁, X₂, and X₃ is NO₂, CN, Br, Cl, SO₂NRR or SO₂NHR. Especially preferred are polymerisable dyes with X₂ and one of X₁ and X₃ being NO₂, CN, Br, Cl, SO₂NRR or SO₂NHR, preferably with R=methyl. Also preferred are polymerisable dyes with X₂ being NO₂, CN, Br, Cl, SO₂NRR or SO₂NHR, preferably with R=methyl, and X₁ and X₃ being H.

The polymerisable groups Y₁, Y₂, Y₃, and Y₄ may be selected from e.g. methacrylate, acrylate, methacrylamide, acrylamide, oxetanes, vinyl, vinyloxy, epoxy, allyl, propenyl ether, styryl groups, in particular methacrylate, acrylate, methacrylamide, and acrylamide. Preferably, groups Y₁, Y₂, Y₃, and Y₄ are selected from methacrylate and acrylate.

In case that R₁ and R₂ are independently of one another linear, branched or cyclic alkyl groups, R₁ and R₂ are preferably C1-C20 alkyl groups, especially alkyl groups having 1 to 10 carbon atoms. C2-C8 alkyl groups are even more preferred.

If R₁ and R₂ are independently of one another groups of the structure L₁-Y₁ or L₂-Y₂, preferably L₁ and L₂ are independently of one another linear or branched C1-C20 alkylene groups, especially alkylene groups having 1 to 10 carbon atoms. Linear C2-C6 alkylen groups are even more preferred. Especially groups where Y₁ and Y₂ are methacrylate or acrylate are preferred. Especially groups Y₁ and Y₂ are identical.

In case that R₃ and R₄ are independently of one another linear, branched or cyclic alkyl groups, R₃ and R₄ are preferably C1-C20 alkyl groups, especially alkyl groups having 1 to 10 carbon atoms. C2-C8 alkyl groups are even more preferred.

If R₃ and R₄ are independently of one another groups of the structure L₃-Y₃ or L₄-Y₄, preferably L₃ and L₄ are independently of one another linear or branched C1-C20 alkylene groups, especially alkylene groups having 1 to 10 carbon atoms. Linear C2-C6 alkylene groups are even more preferred. Especially groups where Y₃ and Y₄ are methacrylate or acrylate are preferred. Especially groups Y₃ and Y₄ are identical.

Preferably, R′ is a linear or branched C1-C4 alkyl group or OR₅, H, NHCOR₆ or NHSO₂R₇ with R₅, R₆, and R₇ preferably independently of one another linear or branched C1-C4 alkyl groups. It is especially preferred to use polymerisable dyes with R′=CH₃ or OCH₃.

Preferably, polymerisable dyes with R″=H are used.

Preferred polymerisable dyes are in particular those dyes in which all variables have the preferred meanings.

In a preferred group of polymerisable dyes of the Formula (1), R₁ and R₂ stand for linear, branched or cyclic alkyl groups and R₃ and R₄ stand for the structures L₃-Y₃ or L₄-Y₄. Particularly preferred are polymerisable dyes where R₁ and R₂ as well as R₃ and R₄ are identical. Particular preference is given to polymerisable dyes in which both R₁ and R₂ and also R₃ and R₄ have the preferred meanings, especially in combination with the preferred groups of X₁, X₂, and X₃ and R′ and R″.

In another preferred group of polymerisable dyes of the Formula (1), R₃ and R₄ stand for linear, branched or cyclic alkyl groups and R₁ and R₂ stand for the structures L₁-Y₁ or L₂-Y₂. Particularly preferred are polymerisable dyes where R₃ and R₄ as well as R₁ and R₂ are identical. Particular preference is given to polymerisable dyes in which both R₁ and R₂ and also R₃ and R₄ have the preferred meanings, especially in combination with the preferred groups of X₁, X₂, and X₃ and R′ and R″.

Particular preference is given to polymerisable dyes according to Formulas (2) to (5):

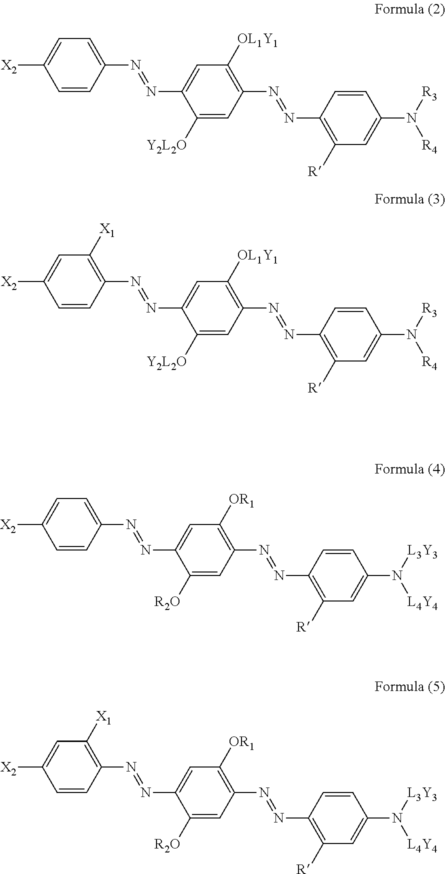

### Wherein

X₁ stands for NO₂ or CN;
X₂ stands for NO₂, CN or halogen;
L₁, L₂, L₃, and L₄ stand for C2-C10 alkylene;
Y₁, Y₂, Y₃, and Y₄ stand for methacrylate or acrylate;
R₁, R₂, R₃, and R₄ stand for C2-C10 alkyl, and
R′ stands for CH₃ or OCH₃. Examples of preferred polymerisable dyes of Formulas (2) to (5) are listed in Table 1. Particularly preferred are Dye 1, Dye 2, and Dye3.

TABLE 1

| | |
|---|---|
| Dye 1 | 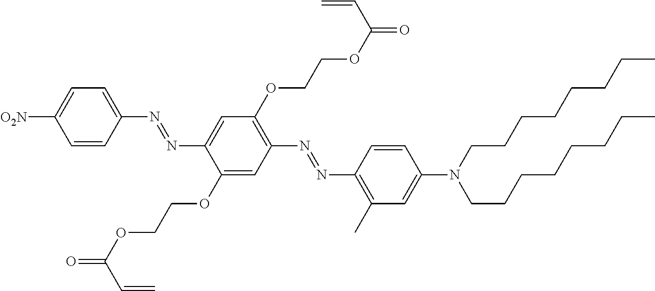 [SMILES: C=CC(=O)OCCOc1cc(/N=N/c2ccc(N(CCCCCCCC)CCCCCCCC)cc2C)c(OCCOC(=O)C=C)cc1/N=N/c1ccc([N+](=O)[O-])cc1] |
| Dye 2 | 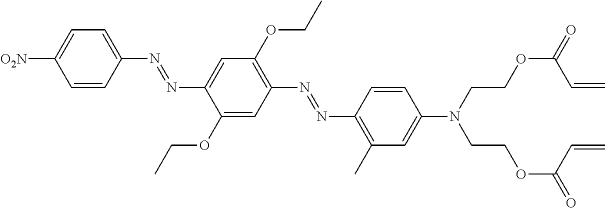 [SMILES: C=CC(=O)OCCN(CCOC(=O)C=C)c1ccc(/N=N/c2cc(OCC)c(/N=N/c3ccc([N+](=O)[O-])cc3)cc2OCC)c(C)c1] |
| Dye 3 | 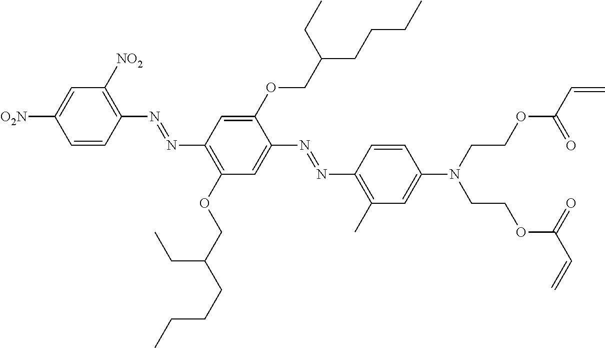 [SMILES: C=CC(=O)OCCN(CCOC(=O)C=C)c1ccc(/N=N/c2cc(OCC(CC)CCCC)c(/N=N/c3ccc([N+](=O)[O-])cc3[N+](=O)[O-])cc2OCC(CC)CCCC)c(C)c1] |
| Dye 4 | 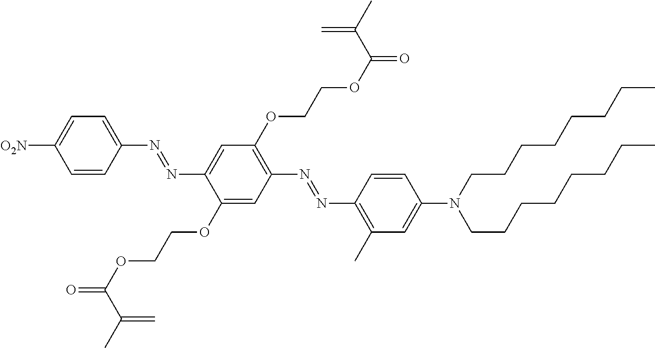 [SMILES: C=C(C)C(=O)OCCOc1cc(/N=N/c2ccc(N(CCCCCCCC)CCCCCCCC)cc2C)c(OCCOC(=O)C(=C)C)cc1/N=N/c1ccc([N+](=O)[O-])cc1] |
| Dye 5 | 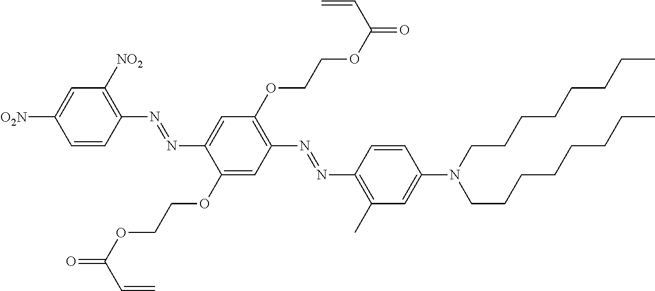 [SMILES: C=CC(=O)OCCOc1cc(/N=N/c2ccc([N+](=O)[O-])cc2[N+](=O)[O-])c(OCCOC(=O)C=C)cc1/N=N/c1ccc(N(CCCCCCCC)CCCCCCCC)cc1C] |
| Dye 6 | 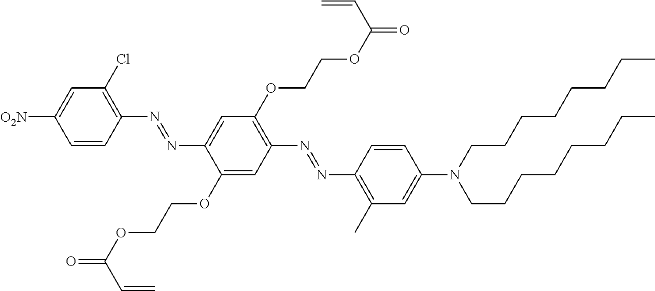 [SMILES: C=CC(=O)OCCOc1cc(/N=N/c2ccc([N+](=O)[O-])cc2Cl)c(OCCOC(=O)C=C)cc1/N=N/c1ccc(N(CCCCCCCC)CCCCCCCC)cc1C] |
| Dye 7 | 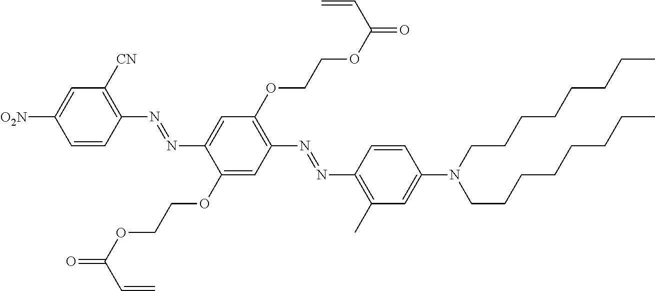 [SMILES: C=CC(=O)OCCOc1cc(/N=N/c2ccc([N+](=O)[O-])cc2C#N)c(OCCOC(=O)C=C)cc1/N=N/c1ccc(N(CCCCCCCC)CCCCCCCC)cc1C] |
| Dye 8 | 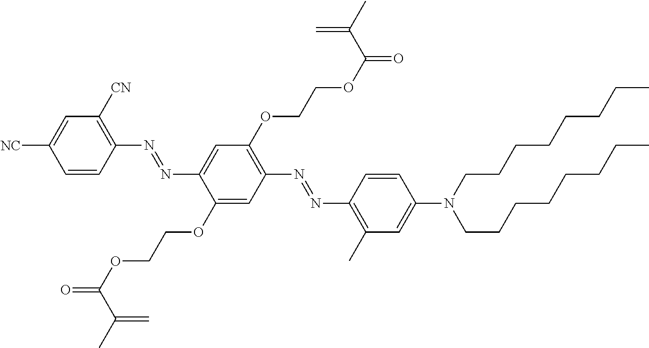 [SMILES: C=C(C)C(=O)OCCOc1cc(/N=N/c2ccc(C#N)cc2C#N)c(OCCOC(=O)C(=C)C)cc1/N=N/c1ccc(N(CCCCCCCC)CCCCCCCC)cc1C] |
| Dye 9 | 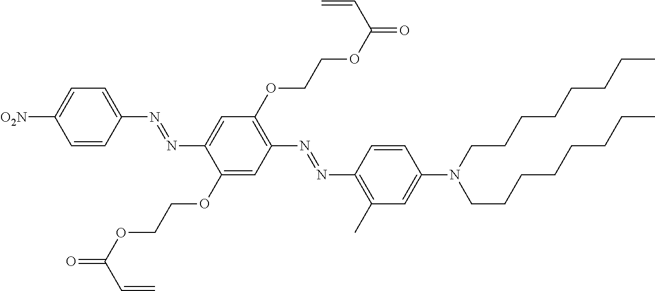 [SMILES: C=CC(=O)OCCOc1cc(/N=N/c2ccc(N(CCCCCCCC)CCCCCCCC)cc2C)c(OCCOC(=O)C=C)cc1/N=N/c1ccc([N+](=O)[O-])cc1] |
| Dye 10 | 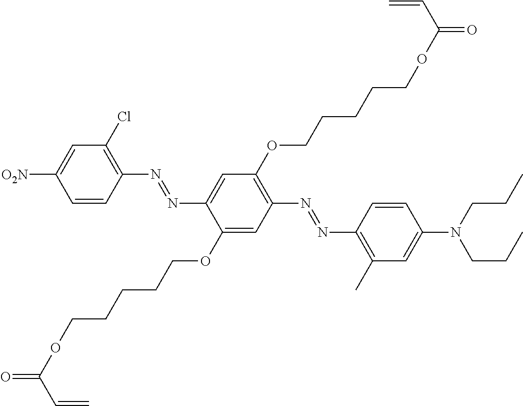 [SMILES: C=CC(=O)OCCCCCOc1cc(/N=N/c2ccc([N+](=O)[O-])cc2Cl)c(OCCCCCOC(=O)C=C)cc1/N=N/c1ccc(N(CCC)CCC)cc1C] |
| Dye 11 | 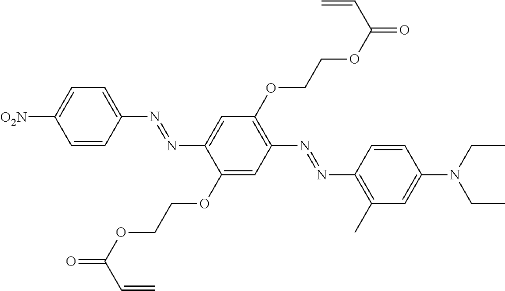 [SMILES: C=CC(=O)OCCOc1cc(/N=N/c2ccc(N(CC)CC)cc2C)c(OCCOC(=O)C=C)cc1/N=N/c1ccc([N+](=O)[O-])cc1] |
| Dye 12 | 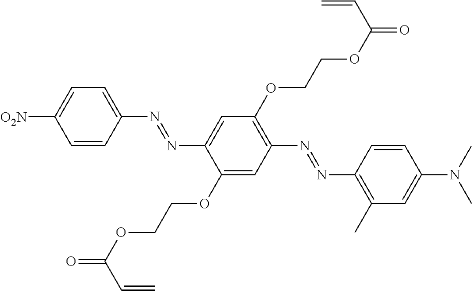 [SMILES: C=CC(=O)OCCOc1cc(/N=N/c2ccc(N(C)C)cc2C)c(OCCOC(=O)C=C)cc1/N=N/c1ccc([N+](=O)[O-])cc1] |
| Dye 13 | 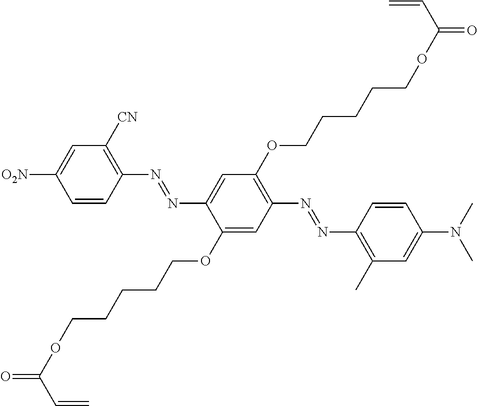 [SMILES: C=CC(=O)OCCCCCOc1cc(/N=N/c2ccc([N+](=O)[O-])cc2C#N)c(OCCCCCOC(=O)C=C)cc1/N=N/c1ccc(N(C)C)cc1C] |
| Dye 14 | 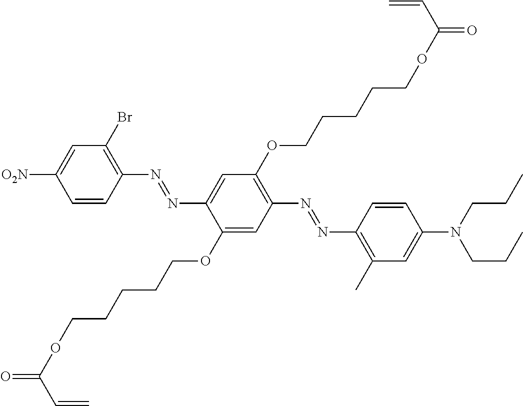 [SMILES: C=CC(=O)OCCCCCOc1cc(/N=N/c2ccc([N+](=O)[O-])cc2Br)c(OCCCCCOC(=O)C=C)cc1/N=N/c1ccc(N(CCC)CCC)cc1C] |
| Dye 15 | 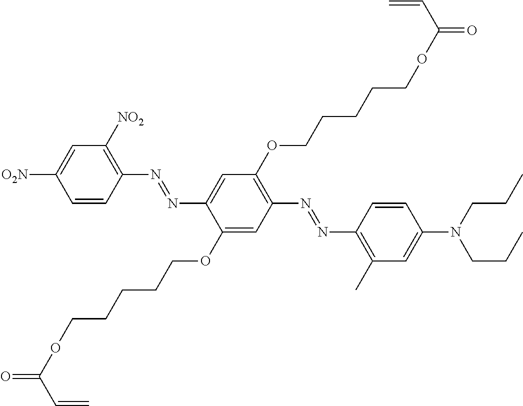 [SMILES: C=CC(=O)OCCCCCOc1cc(/N=N/c2ccc([N+](=O)[O-])cc2[N+](=O)[O-])c(OCCCCCOC(=O)C=C)cc1/N=N/c1ccc(N(CCC)CCC)cc1C] |
| Dye 16 | 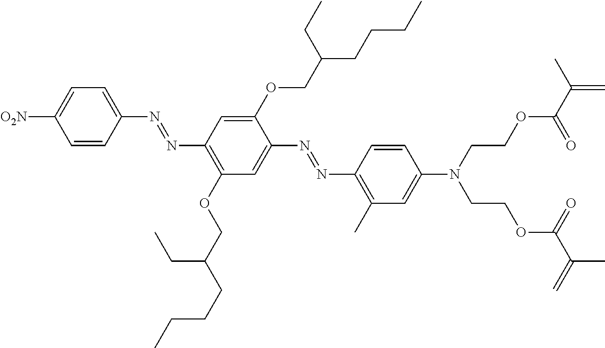 [SMILES: C=C(C)C(=O)OCCN(CCOC(=O)C(=C)C)c1ccc(/N=N/c2cc(OCC(CC)CCCC)c(/N=N/c3ccc([N+](=O)[O-])cc3)cc2OCC(CC)CCCC)c(C)c1] |
| Dye 17 | 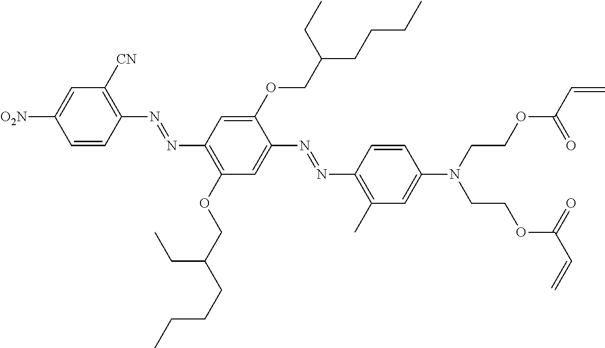 [SMILES: C=CC(=O)OCCN(CCOC(=O)C=C)c1ccc(/N=N/c2cc(OCC(CC)CCCC)c(/N=N/c3ccc([N+](=O)[O-])cc3C#N)cc2OCC(CC)CCCC)c(C)c1] |
| Dye 18 | 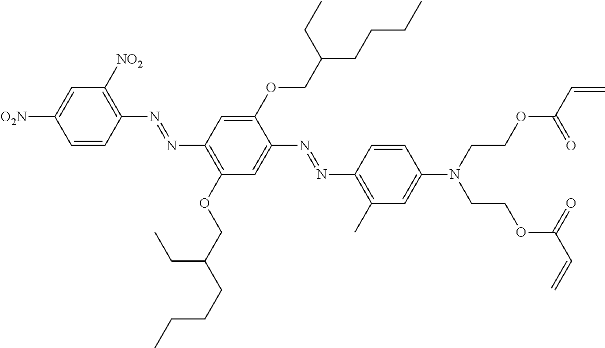 [SMILES: C=CC(=O)OCCN(CCOC(=O)C=C)c1ccc(/N=N/c2cc(OCC(CC)CCCC)c(/N=N/c3ccc([N+](=O)[O-])cc3[N+](=O)[O-])cc2OCC(CC)CCCC)c(C)c1] |
| Dye 19 | 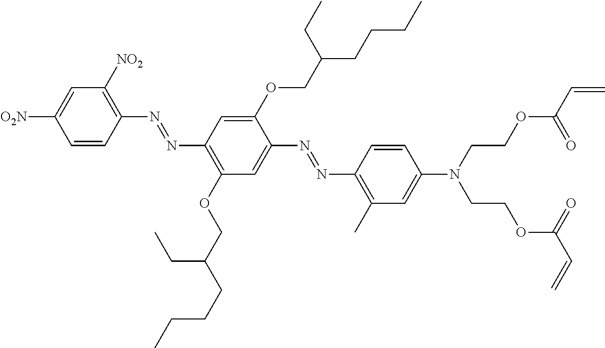 [SMILES: C=CC(=O)OCCN(CCOC(=O)C=C)c1ccc(/N=N/c2cc(OCC(CC)CCCC)c(/N=N/c3ccc([N+](=O)[O-])cc3[N+](=O)[O-])cc2OCC(CC)CCCC)c(C)c1] |
| Dye 20 | 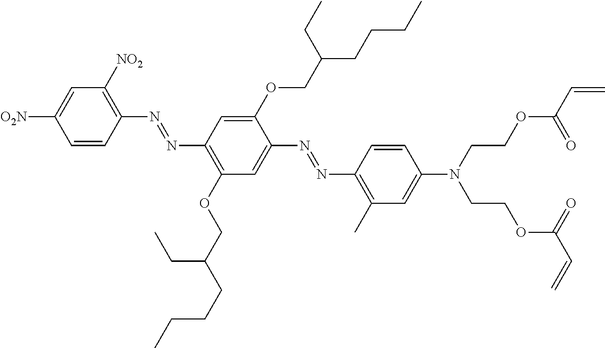 [SMILES: C=CC(=O)OCCN(CCOC(=O)C=C)c1ccc(/N=N/c2cc(OCC(CC)CCCC)c(/N=N/c3ccc([N+](=O)[O-])cc3[N+](=O)[O-])cc2OCC(CC)CCCC)c(C)c1] |
| Dye 21 | 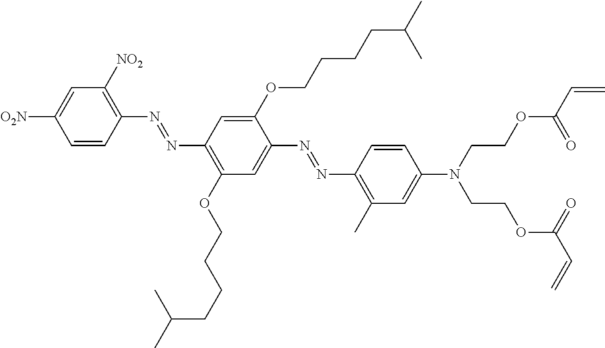 [SMILES: C=CC(=O)OCCN(CCOC(=O)C=C)c1ccc(/N=N/c2cc(OCCCCC(C)C)c(/N=N/c3ccc([N+](=O)[O-])cc3[N+](=O)[O-])cc2OCCCCC(C)C)c(C)c1] |
| Dye 22 | 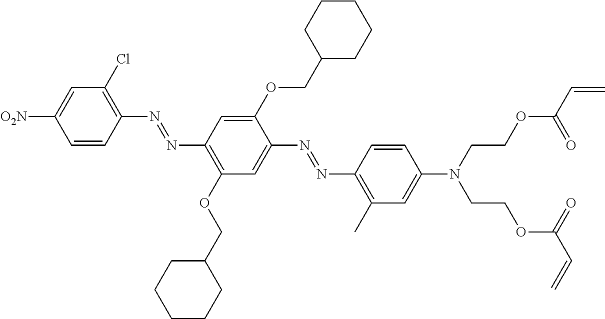 [SMILES: C=CC(=O)OCCN(CCOC(=O)C=C)c1ccc(/N=N/c2cc(OCC3CCCCC3)c(/N=N/c3ccc([N+](=O)[O-])cc3Cl)cc2OCC2CCCCC2)c(C)c1] |
| Dye 23 | 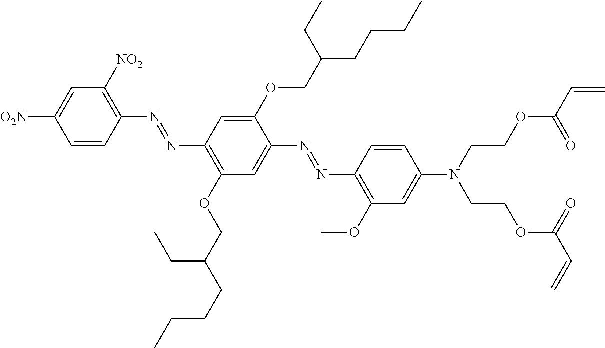 [SMILES: C=CC(=O)OCCN(CCOC(=O)C=C)c1ccc(/N=N/c2cc(OCC(CC)CCCC)c(/N=N/c3ccc([N+](=O)[O-])cc3[N+](=O)[O-])cc2OCC(CC)CCCC)c(OC)c1] |
| Dye 24 | 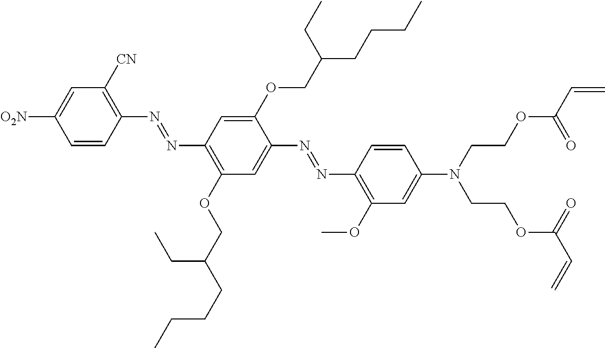 [SMILES: C=CC(=O)OCCN(CCOC(=O)C=C)c1ccc(/N=N/c2cc(OCC(CC)CCCC)c(/N=N/c3ccc([N+](=O)[O-])cc3C#N)cc2OCC(CC)CCCC)c(OC)c1] |
| Dye 25 | 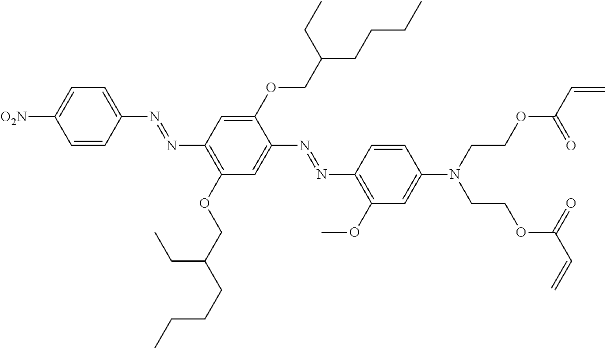 [SMILES: C=CC(=O)OCCN(CCOC(=O)C=C)c1ccc(/N=N/c2cc(OCC(CC)CCCC)c(/N=N/c3ccc([N+](=O)[O-])cc3)cc2OCC(CC)CCCC)c(OC)c1] |
| Dye 26 | 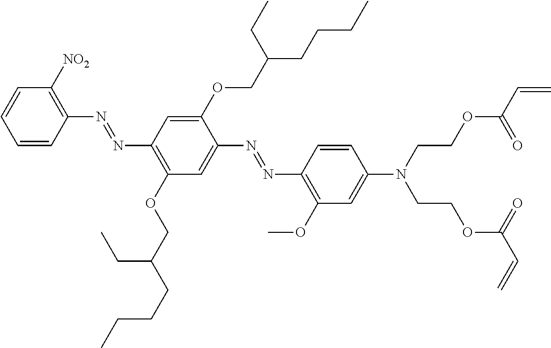 [SMILES: C=CC(=O)OCCN(CCOC(=O)C=C)c1ccc(/N=N/c2cc(OCC(CC)CCCC)c(/N=N/c3ccccc3[N+](=O)[O-])cc2OCC(CC)CCCC)c(OC)c1] |

The following schemes show by way of example for Dyes 1, 2, and 3 the synthesis of polymerisable dyes of the invention, especially for dyes of Formulas (2) to (5), which can be carried out by processes and under conditions known to the person skilled in the art:

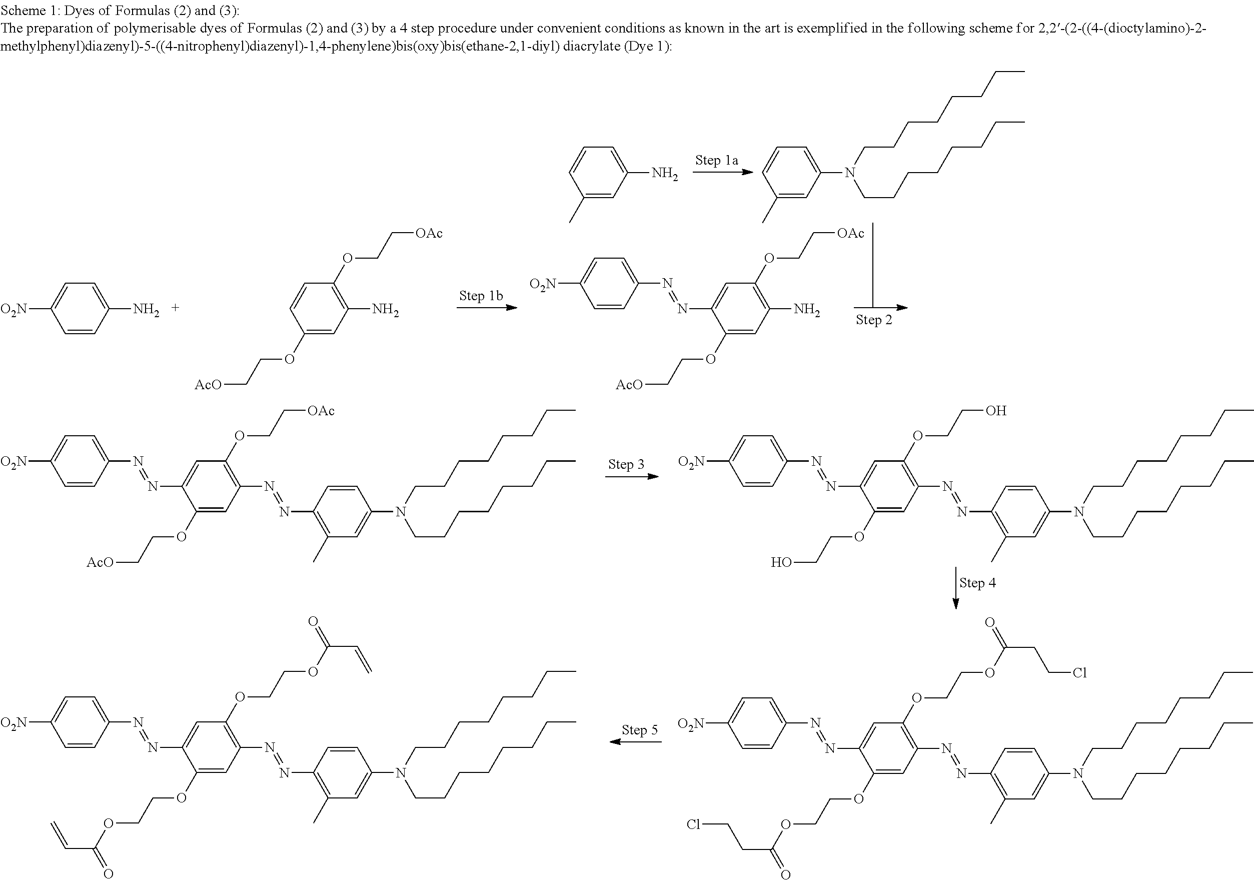

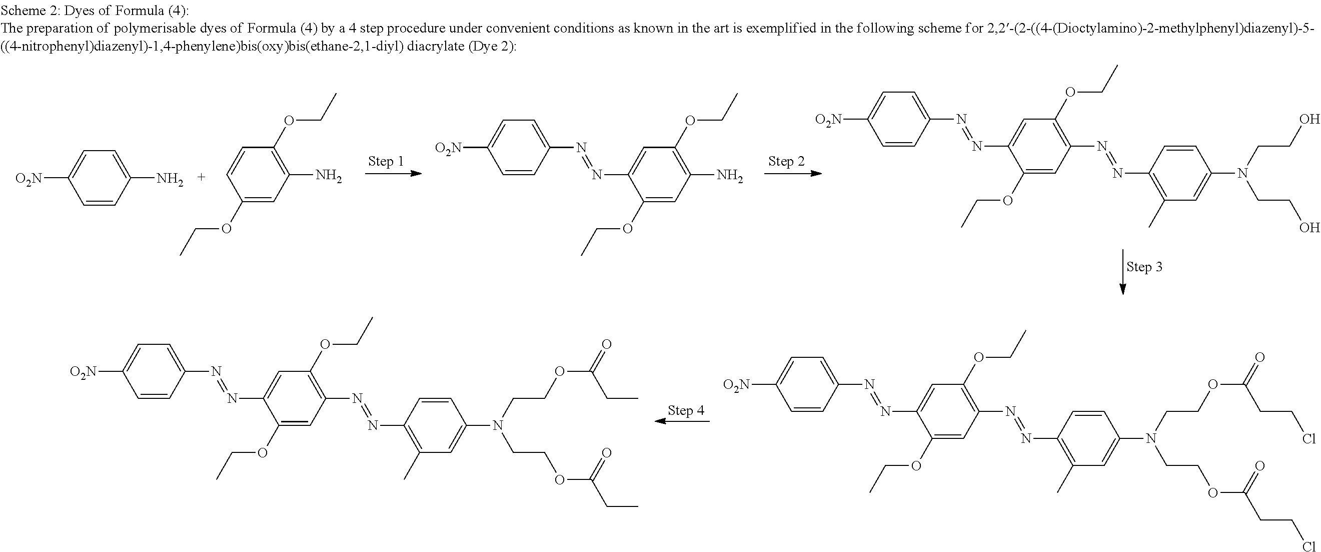 [SMILES: Nc1ccc([N+](=O)[O-])cc1 ; CCOc1ccc(OCC)c(N)c1 ; CCOc1cc(/N=N/c2ccc([N+](=O)[O-])cc2)c(OCC)cc1N ; CCOc1cc(/N=N/c2ccc(N(CCO)CCO)cc2C)c(OCC)cc1/N=N/c1ccc([N+](=O)[O-])cc1 ; CCOc1cc(/N=N/c2ccc(N(CCOC(=O)CC)CCOC(=O)CC)cc2C)c(OCC)cc1/N=N/c1ccc([N+](=O)[O-])cc1 ; CCOc1cc(/N=N/c2ccc(N(CCOC(=O)CCCl)CCOC(=O)CCCl)cc2C)c(OCC)cc1/N=N/c1ccc([N+](=O)[O-])cc1]

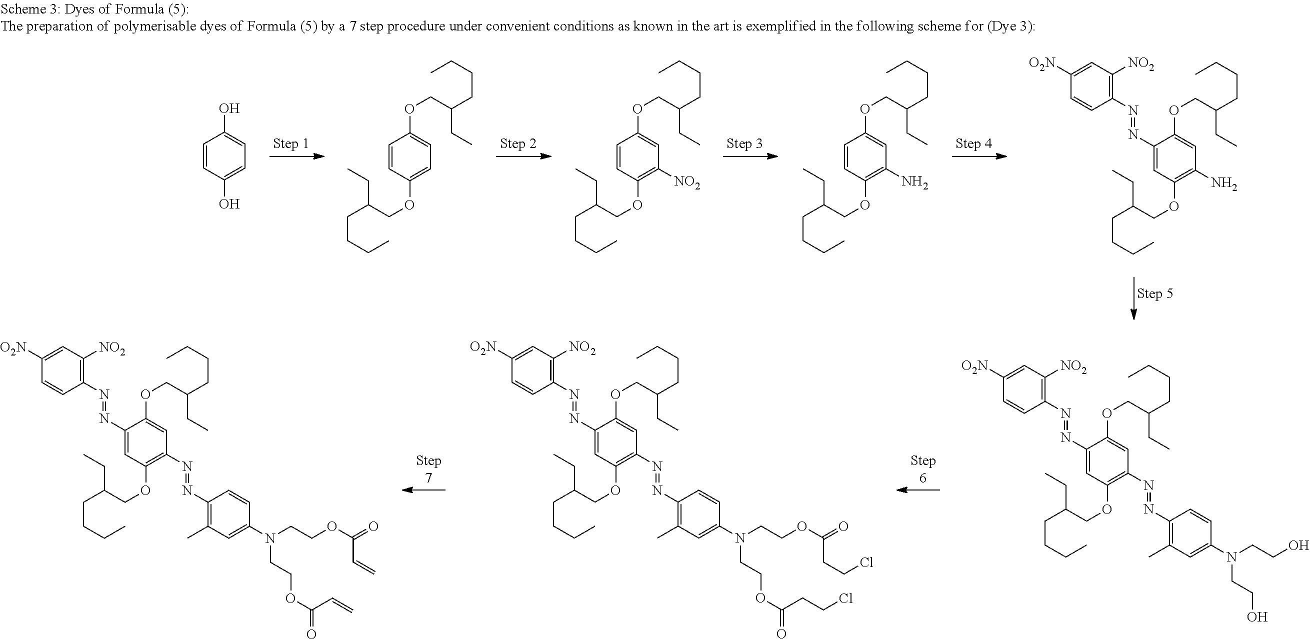

The preparation of further polymerisable dyes according to the invention can be carried out analogously to the illustrative reactions shown above. Further subjects of the invention are polymerisable dyes of Formulas (1) to (5) and the processes of their preparation as disclosed in Schemes 1 to 3.

All process steps described above and below can be carried out using known techniques and standard equipments which are described in prior art and are well-known to the skilled person.

The present process for the preparation of polymer particles preferably comprises a) the polymerisation of at least one polymerisable dye of Formula (1), at least one monomer, at least one initiator, and optionally at least one charged co-monomer by dispersion polymerisation in at least one non-aqueous, non-polar solvent, and optionally b) washing and drying the polymer particles.

The polymer particles of the invention can preferably be prepared by copolymerisation in a non-aqueous, non-polar solvent, especially by copolymerisation of at least one polymerisable dye of Formula (1), methyl methacrylate (MMA), methacrylic acid, stabiliser, and initiator, or by emulsion polymerisation, especially by an emulsifier-free batch emulsion polymerisation process.

Preferably black polymerisable dyes of Formula (1) are used to prepare black polymer particles for use in electrowetting devices. Preferably one black polymerisable dye is used. However, at least two polymerisable dyes of Formula (1) may be used for the preparation of black polymer particles. In a variant of the invention, at least one of the polymerisable dyes of Formula (1) is used in combination with at least one other polymerisable dye, e.g. those described in WO 2010/089057 and in the earlier patent application WO 2012/019704. Such combinations may be especially useful for the preparation of polymer particles which are of a neutral black colour. Optionally yellow polymerisable dyes like Dye A and Dye B or cyan polymerisable dyes like Dye C or magenta polymerisable dyes like Dye D may be used in combination with dyes of Formula (1).

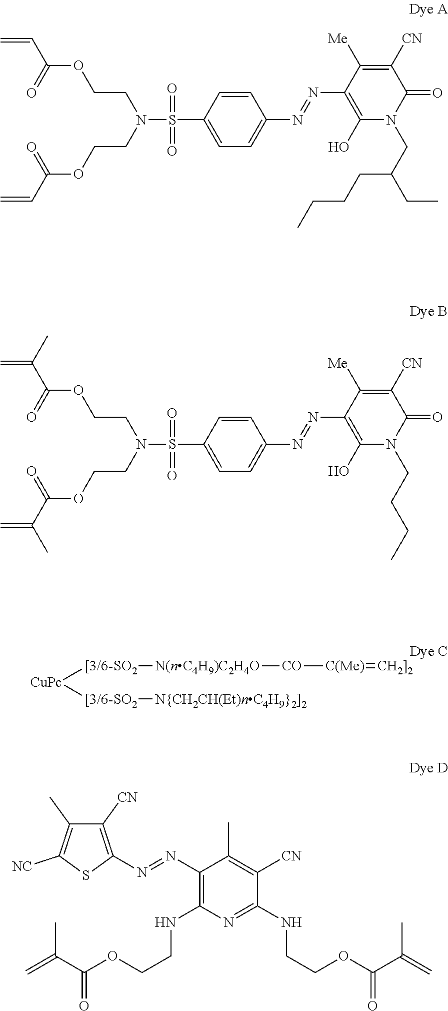

Preferably, the polymer particles of the invention can be prepared in a simple 1-step reaction in a non-aqueous, preferably non-polar medium. Solvents with a low dielectric constant are preferably used. So, the particles are formed directly in a solvent which is highly suitable as a non-polar phase of EWD. This also allows transfer to other solvents suitable for EWD if so desired. The preferred solvents are non-polar hydrocarbon solvents, especially such used in the non-polar phase of EWD, i.e. the Isopar series (Exxon-Mobil), Norpar, Shell-Sol (Shell), Sol-Trot (Shell), naphtha, and other petroleum solvents, as well as long chain alkanes such as dodecane, tetradecane, hexadecane, decane and nonane. Especially preferred is dodecane. Preferably the polymer particles are simply separated from the reaction suspension by filtration, preferably by pouring the suspension through a pore size filter, i.e. a 5 μm pore size filter, or the particles can be cleaned by centrifuging.

The selection of the polymerisation conditions depends on the required size and size distribution of the particles. Adjustment of polymerisation conditions is well known to someone skilled in the art.

Preferably, a batch polymerisation process is used wherein all reactants are completely added at the outset of the polymerisation process. In such process only relatively few variables have to be adjusted for a given formulation. Preferred changes which can be made in such cases are to the reaction temperature, reactor design and the type and speed of stirring.

Thus, a batch polymerisation process is used for manufacture versus a semi-continuous batch process because of limited versatility and simple evaluations of reaction formulation.

This route avoids the use of aqueous medium, whereas preparation in aqueous medium has obvious advantages in terms of health, safety and environmental terms, ultimately the coloured polymer particles have to be redispersed in a non-aqueous, non-polar medium for use in EWD. If the particles are prepared in water, then usually a long and power consuming process such as freeze drying or spray drying is required to remove the water. This route avoids such time consuming steps and the coloured polymer particles do not have to be redispersed in to a suitable non-polar solvent for EWD. This route also avoids introducing unwanted traces of water into the EWD dispersion. Therefore, this process provides a one-step reaction to prepare coloured particles suitable for EWD, without the requirement of freeze or spray drying enabling a cost effective production process. No transfer of solvents is required.

Preferably the polymerisation is a free radical polymerisation.

Usually, a monomer composition according to the invention comprises at least one polymerisable dye according to Formula (1), at least one monomer, at least one initiator, preferably at least one steric stabiliser, and optionally at least one charged co-monomer in a non-aqueous solvent.

Preferably, a monomer composition according to the invention comprises at least one polymerisable dye according to Formula (1), at least one monomer, a steric stabiliser, an initiator, and a non-aqueous, non-polar solvent.

The monomers described in the following for preparation of the polymer particles can be combined with the polymerisable dyes to produce a polymerisable dye/monomer mixture and/or the monomers can be incorporated stepwise into the polymerisable mixture to produce special effects, for example a core-shell effect so that there is more dye on the shell of the particles. Particularly preferable are monomers which are compatible to the polymerisable dye.

The polymer particles can be prepared from most monomer types, in particular methacrylates, acrylates, acrylamides, methacrylamides, acrylonitriles, α-substituted acrylates, styrenes and vinyl ethers, vinyl esters, propenyl ethers, oxetanes and epoxys but would typically be prepared from largest percentage to be monomer, then cross-linker, and include a charged monomer (e.g. quaternised monomer).

The following are all examples which could be used and which are commercially available from the Sigma-Aldrich chemical company. Mixtures of monomers may also be used.

### Methacrylates:

Methyl methacrylate (MMA), Ethyl methacrylate (EMA), n-Butyl methacrylate (BMA), 2-Aminoethyl methacrylate hydrochloride, Allyl methacrylate, Benzyl methacrylate, 2-Butoxyethyl methacrylate, 2-(tert-Butylamino)ethyl methacrylate, Butyl methacrylate, tert-Butyl methacrylate, Caprolactone 2-(methacryloyloxy)ethyl ester, 3-Chloro-2-hydroxypropyl methacrylate, Cyclohexyl methacrylate, 2-(Diethylamino)ethyl methacrylate, Di(ethylene glycol) methyl ether methacrylate, 2-(Dimethylamino)ethyl methacrylate, 2-Ethoxyethyl methacrylate, Ethylene glycol dicyclopentenyl ether methacrylate, Ethylene glycol methyl ether methacrylate, Ethylene glycol phenyl ether methacrylate, 2-Ethylhexyl methacrylate, Furfuryl methacrylate, Glycidyl methacrylate, Glycosyloxyethyl methacrylate, Hexyl methacrylate, Hydroxybutyl methacrylate, 2-Hydroxyethyl methacrylate, 2-Hydroxyethyl methacrylate, Hydroxypropyl methacrylate Mixture of hydroxypropyl and hydroxyisopropyl methacrylates, 2-Hydroxypropyl 2-(methacryloyloxy)ethyl phthalate, Isobornyl methacrylate, Isobutyl methacrylate, 2-Isocyanatoethyl methacrylate, Isodecyl methacrylate, Lauryl methacrylate, Methacryloyl chloride, Methacrylic acid, 2-(Methylthio)ethyl methacrylate, mono-2-(Methacryloyloxy)ethyl maleate, mono-2-(Methacryloyloxy)ethyl succinate, Pentabromophenyl methacrylate, Phenyl methacrylate, Phosphoric acid 2-hydroxyethyl methacrylate ester, Stearyl methacrylate, 3-Sulfopropyl methacrylate potassium salt, Tetrahydrofurfuryl methacrylate, 3-(Trichlorosilyl)propyl methacrylate, Tridecyl methacrylate, 3-(Trimethoxysilyl)propyl methacrylate, 3,3,5-Trimethylcyclohexyl methacrylate, Trimethylsilyl methacrylate, Vinyl methacrylate. Preferably Methyl methacrylate (MMA), Methacrylic acid, Ethyl methacrylate (EMA), and/or n-Butyl methacrylate (BMA) are used.

### Acrylates:

Acrylic acid, 4-Acryloylmorpholine, [2-(Acryloyloxy)ethyl]trimethylammonium chloride, 2-(4-Benzoyl-3-hydroxyphenoxy)ethyl acrylate, Benzyl 2-propylacrylate, 2-Butoxyethyl acrylate, Butyl acrylate, tert-Butyl acrylate, 2-[(Butylamino)carbonyl]oxy]ethyl acrylate, tert-Butyl 2-bromoacrylate, 4-tert-Butylcyclohexyl acrylate, 2-Carboxyethyl acrylate, 2-Carboxyethyl acrylate oligomers anhydrous, 2-(Diethylamino)ethyl acrylate, i(ethylene glycol) ethyl ether acrylate technical grade, Di(ethylene glycol) 2-ethylhexyl ether acrylate, 2-(Dimethylamino)ethyl acrylate, 3-(Dimethylamino)propyl acrylate, Dipentaerythritol penta-/hexa-acrylate, 2-Ethoxyethyl acrylate, Ethyl acrylate, 2-Ethylacryloyl chloride, Ethyl 2-(bromomethyl)acrylate, Ethyl cis-(R-cyano)acrylate, Ethylene glycol dicyclopentenyl ether acrylate, Ethylene glycol methyl ether acrylate, Ethylene glycol phenyl ether acrylate, Ethyl 2-ethylacrylate, 2-Ethylhexyl acrylate, Ethyl 2-propylacrylate, Ethyl 2-(trimethylsilylmethyl)acrylate, Hexyl acrylate, 4-Hydroxybutyl acrylate, 2-Hydroxyethyl acrylate, 2-Hydroxy-3-phenoxypropyl acrylate, Hydroxypropyl acrylate, Isobornyl acrylate, Isobutyl acrylate, Isodecyl acrylate, Isooctyl acrylate, Lauryl acrylate, Methyl 2-acetamidoacrylate, Methyl acrylate, Methyl α-bromoacrylate, Methyl 2-(bromomethyl)acrylate, Methyl 3-hydroxy-2-methylenebutyrate, Octadecyl acrylate, Pentabromobenzyl acrylate, Pentabromophenyl acrylate, Poly(ethylene glycol) methyl ether acrylate, Poly(propylene glycol) acrylate, Poly(propylene glycol) methyl ether acrylate Soybean oil, epoxidized acrylate, 3-Sulfopropyl acrylate potassium salt, Tetrahydrofurfuryl acrylate, 3-(Trimethoxysilyl)propyl acrylate, 3,5,5-Trimethylhexyl acrylate. Preferably Methyl acrylate, acrylic acid, Ethyl acrylate (EMA), and/or n-Butyl acrylate (BMA) are used.

### Acrylamides:

2-Acrylamidoglycolic acid, 2-Acrylamido-2-methyl-1-propanesulfonic acid, 2-Acrylamido-2-methyl-1-propanesulfonic acid sodium salt solution, (3-Acrylamidopropyl)trimethylammonium chloride solution, 3-Acryloylamino-1-propanol solution purum, N-(Butoxymethyl)acrylamide, N-tert-Butylacrylamide, Diacetone acrylamide, N,N-Dimethylacrylamide, N-[3-(Dimethylamino)propyl]methacrylamide, N-Hydroxyethyl acrylamide, N-(Hydroxymethyl)acrylamide, N-(Isobutoxymethyl)acrylamide, N-Isopropylacrylamide, N-Isopropylmethacrylamide, Methacrylamide, N-Phenylacrylamide, N-[Tris(hydroxymethyl)methyl]acrylamide,

### Styrenes

Styrene, Divinyl benzene, 4-Acetoxystyrene, 4-Benzyloxy-3-methoxystyrene, 2-Bromostyrene, 3-Bromostyrene, 4-Bromostyrene, α-Bromostyrene, 4-tert-Butoxystyrene, 4-tert-Butylstyrene, 4-Chloro-α-methylstyrene, 2-Chlorostyrene, 3-Chlorostyrene, 4-Chlorostyrene, 2,6-Dichlorostyrene, 2,6-Difluorostyrene, 1,3-Diisopropenylbenzene, 3,4-Dimethoxystyrene, α,2-Dimethylstyrene, 2,4-Dimethylstyrene, 2,5-Dimethylstyrene, N,N-Dimethylvinylbenzylamine, 2,4-Diphenyl-4-methyl-1-pentene, 4-Ethoxystyrene, 2-Fluorostyrene, 3-Fluorostyrene, 4-Fluorostyrene, 2-Isopropenylaniline, 3-Isopropenyl-α,α-dimethylbenzyl isocyanate, Methylstyrene, α-Methylstyrene, 3-Methylstyrene, 4-Methylstyrene, 3-Nitrostyrene, 2,3,4,5,6-Pentafluorostyrene, 2-(Trifluoromethyl)styrene, 3-(Trifluoromethyl)styrene, 4-(Trifluoromethyl)styrene, 2,4,6-Trimethylstyrene. Preferably Styrene and/or Divinyl benzene are used.

### Vinyl Groups

3-Vinylaniline, 4-Vinylaniline, 4-Vinylanisole, 9-Vinylanthracene, 3-Vinylbenzoic acid, 4-Vinylbenzoic acid, Vinylbenzyl chloride, 4-Vinylbenzyl chloride, (Vinylbenzyl)trimethylammonium chloride, 4-Vinylbiphenyl, 2-Vinylnaphthalene, 2-Vinylnaphthalene, Vinyl acetate, Vinyl benzoate, Vinyl 4-tert-butylbenzoate, Vinyl chloroformate, Vinyl chloroformate, Vinyl cinnamate, Vinyl decanoate, Vinyl neodecanoate, Vinyl neononanoate, Vinyl pivalate, Vinyl propionate, Vinyl stearate, Vinyl trifluoroacetate,

Other monomers which may be used are those which have groups to help stabilisation of the particles, e.g. Poly(ethylene glycol) methyl ether acrylate, Poly(ethylene glycol) phenyl ether acrylate, lauryl methacrylate, Poly(ethylene glycol) methyl ether acrylate, Poly(propylene glycol) methyl ether acrylate, Lauryl acrylate and fluorinated monomers of above.

Some of the monomers have groups for further reaction if so desired, e.g. Glycidyl ethacrylate, 2-Hydroxyethyl methacrylate.

The following compounds can be used as intraparticle crosslinking monomers for solubility control and solvent swelling resistance: ethylene glycol dimethacrylate (EGDMA), allyl methacrylate (ALMA), divinyl benzene, Bis[4-(vinyloxy)butyl]adipate, Bis[4-(vinyloxy)butyl] 1,6-hexanediylbiscarbamate, Bis[4-(vinyloxy)butyl]isophthalate, Bis[4-(vinyloxy)butyl](methylenedi-4,1-phenylene)biscarbamate, Bis[4-(vinyloxy)butyl]succinate, Bis[4-(vinyloxy)butyl]terephthalate, Bis[4-(vinyloxymethyl)cyclohexylmethyl]glutarate, 1,4-Butanediol divinyl ether, 1,4-Butanediol vinyl ether, Butyl vinyl ether, tert-Butyl vinyl ether, 2-Chloroethyl vinyl ether, 1,4-Cyclohexanedimethanol divinyl ether, 1,4-Cyclohexanedimethanol vinyl ether, Di(ethylene glycol)divinyl ether, Di(ethylene glycol) vinyl ether, Ethylene glycol butyl vinyl ether, Ethylene glycol vinyl ether, Tris[4-(vinyloxy)butyl]trimellitate, 3-(Acryloyloxy)-2-hydroxypropyl methacrylate, Bis[2-(methacryloyloxy)ethyl]phosphate, Bisphenol A propoxylate diacrylate, 1,3-Butanediol diacrylate, 1,4-Butanediol diacrylate, 1,3-Butanediol dimethacrylate, 1,4-Butanediol dimethacrylate, N,N′-(1,2-Di hydroxyethylene)bisacrylamide, Di(trimethylolpropane)tetraacrylate, Diurethane dimethacrylate, N,N′-Ethylenebis(acrylamide), Glycerol 1,3-diglycerolate, Glycerol dimethacrylate, 1,6-Hexanediol diacrylate, 1,6-Hexanediol dimethacrylate, 1,6-Hexanediylbis[oxy(2-hydroxy-3,1-propanediyl)]bisacrylate, Hydroxypivalyl hydroxypivalate bis[6-(acryloyloxy)hexanoate], Neopentyl glycol diacrylate, Pentaerythritol diacrylate, Pentaerythritol tetraacrylate, Pentaerythritol triacrylate, Poly(propylene glycol)diacrylate, Poly(propylene glycol)dimethacrylate, 1,3,5-Triacryloylhexahydro-1,3,5-triazine, Tricyclo[5.2.1.0]decanedimethanol diacrylate, Trimethylolpropane benzoate diacrylate, Trimethylolpropane ethoxylate methyl ether diacrylate, Trimethylolpropane ethoxylate triacrylate, Trimethylolpropane triacrylate, Trimethylolpropane tri methacrylate, Tris[2-(acryloyloxy)ethyl]isocyanurate, Tri(propylene glycol)diacrylate.

Optionally, the monomer composition comprises at least one charged co-monomer.

Examples of cationic monomers for particle stability and particle size control are 2-methacryloxy ethyl trimethyl ammonium chloride (MOTAC), acryloxy ethyl trimethyl ammonium chloride (AOTAC), [3-(Methacryloylamino)propyl]trimethylammonium chloride, [2-(Methacryloyloxy)ethyl]trimethylammonium methyl sulfate solution, tetraallyl ammonium chloride, diallyl dimethyl ammonium chloride, (Vinylbenzyl)trimethylammonium chloride. Preferably 2-methacryloxy ethyl trimethyl ammonium chloride (MOTAC) and acryloxy ethyl trimethyl ammonium chloride (AOTAC) are used.

Examples of anionic monomers are sodium, potassium or triethylamine salts of methacrylic acid, Acrylic acid, 2-(Trifluoromethyl)acrylic acid, 3-(2-Furyl)acrylic acid, 3-(2-Thienyl)acrylic acid, 3-(Phenylthio)acrylic acid, Poly(acrylic acid) potassium salt, Poly(acrylic acid) sodium salt, Poly(acrylic acid), Poly(acrylic acid, sodium salt) solution, trans-3-(4-Methoxybenzoyl)acrylic acid, 2-Methoxycinnamic acid, 3-Indoleacrylic acid, 3-Methoxycinnamic acid, 4-Imidazoleacrylic acid, 4-Methoxycinnamic acid, Poly(styrene)-block-poly(acrylic acid), Poly(acrylonitrile-co-butadiene-co-acrylic acid), dicarboxy terminated, Poly(acrylonitrile-co-butadiene-co-acrylic acid), dicarboxy terminated, glycidyl methacrylate diester,

2,3-Diphenyl-Acrylic Acid, 2-Me-Acrylic Acid, 3-(1-Naphthyl)Acrylic Acid, 3-(2,3,5,6-Tetramethylbenzoyl)Acrylic Acid, 3-(4-Methoxyphenyl)Acrylic Acid, 3-(4-Pyridyl)Acrylic Acid, 3-p-Tolyl-Acrylic Acid, 5-Norbornene-2-Acrylic Acid, Trans-3-(2,5-Dimethylbenzoyl)Acrylic Acid, Trans-3-(4-Ethoxybenzoyl)Acrylic Acid, Trans-3-(4-Methoxybenzoyl)Acrylic Acid, 2,2′-(1,3-Phenylene)Bis(3-(2-aminophenyl)Acrylic Acid), 2,2′-(1,3-Phenylene)Bis(3-(2-Aminophenyl)Acrylic Acid) hydrochloride, 2,2′-(1,3-Phenylene)Bis(3-(2-Nitrophenyl)Acrylic Acid), 2-[2-(2′,4′-Difluoro[1,1′-Biphenyl]-4-Yl)-2-Oxoethyl]Acrylic Acid, 2-(2-(2-Chloroanilino)-2-Oxoethyl)-3-(4-Methoxyphenyl)Acrylic Acid, 2-(2-((2-Hydroxyethyl)Amino)-2-Oxoethyl)-3-(4-Methoxyphenyl)Acrylic Acid, 2-(2-(Cyclohexylamino)-2-Oxoethyl)-3-(4-Methoxyphenyl)Acrylic Acid.

A preferred monomer composition comprises methyl methacrylate and methacrylic acid, in combination with at least one polymerisable dye according to Formula (1). Preferably such monomer compositions comprise at least one polymerisable dye of Formulas (2) to (5). Most preferred are the polymerisable dyes listed in Table 1, especially Dye 1, Dye 2, and Dye3.

Preferably, an oil soluble initiator is used in the non-aqueous copolymerisation in order to control size, particle morphology and to reduce the residual monomers at the end of the reaction. Preferably an oil-soluble thermal initiator is added in step c) of the present process. Examples are 2,2′-Azobis(4-methoxy-2,4-dimethyl valeronitrile), 2,2′-Azobis(N-butyl2methylpropionamide), 2,2′-Azobis(2,4-dimethyl valeronitrile), Dimethyl 2,2′-azobis(2-methylpropionate), 2,2′-Azobis(2-methylbutyronitrile), also known as Vazo 67 (DuPont), 1,1′-Azobis(cyclohexane-1-carbonitrile), 2,2′-Azobis[N-(2-propenyl)-2-methylpropionamide], 1-[(1-cyano-1-methylethyl)azo]formamide, 2,2′-Azobis(N-cyclohexyl-2-methylpropionamide) (all available from Wako); Vazo 52 and Vazo 64 (available from DuPont), Luperox 331.

Preferably 2,2′-Azobis(2,4-dimethyl valeronitrile), Dimethyl 2,2′-azobis(2-methylpropionate), 2,2′-Azobis(2-methylbutyronitrile) or Vazo 67 are used.

Preferably the polymerisation according to the invention is a free radical polymerisation. Usually, polymerisation compositions as described above are used. A preferred monomer composition comprises methyl methacrylate and methacrylic acid in combination with at least one the polymerisable dyes according to Formula (1). Preferably such monomer compositions comprise at least one polymerisable dye of Formulas (2) to (5). Most preferred are the polymerisable dyes listed in Table 1, especially Dye 1, Dye 2, and Dye3.

The polymerisable composition of the invention usually comprises 0.1-15, preferably 3-12%, by weight of at least one polymerisable dye according to Formula (1), 50-95%, preferably 70-90%, by weight of monomer, 1-40%, preferably 1-10%, by weight of co monomer, and 0.1-10%, preferably 0.1-5%, by weight of initiator, all percentages are based on the total weight of the polymerizable composition (except solvent). Combinations of polymerisable dyes according to Formula (1) with other polymerisable dyes may also be used in such compositions.

Polymer particles prepared according to the invention are preferably spherical particles with a size (diameter) in the range of 50-1200 nm, preferably 50-1000 nm and preferably with a monodisperse size distribution. Preferred particle sizes are 150-950 nm. In a variant of the invention preferred particle sizes are 500-950 nm. Particle sizes are determined by photon correlation spectroscopy of hydrocarbon particle dispersions by a common apparatus such as a Malvern NanoZS particle analyser or preferably by SEM (Scanning Electron Microscopy) and image analysis.

To enhance the surface stabilisation or steric repulsions of the polymeric particles in a non-polar continuous phase, a steric stabiliser is preferably incorporated into the coloured polymer particles. Preferably a non-aqueous dispersion (NAD) stabiliser is adsorbed on to the particle.

Suitable NAD stabilisers are block copolymers with a comb shape structure. Especially block copolymers with a molecular weight of approximately 10,000-100,000 can be used. The molecular weight ratio of the backbone to hairs may be approximately 1:1. The particle dispersion medium (non-polar solvent) preferably is a poor solvent for the backbone. The backbone chemistry preferably is similar to the particle. The length of the hairs preferably is of the order of the distance required to sterically stabilise the particles. The particle dispersion medium preferably is a good solvent for the hairs. It is possible to attach chromophores and/or charging groups to the backbone and or the hairs. NAD stabilisers are commercially available or can be prepared to known methods, e.g. as described in ‘Dispersion Polymerization in Organic Media’, ISBN 0471 054186, edited by K. E. J. Barrett, published by John Wiley and Sons, Copyright 1975, by Imperial Chemical Industries Ltd. Preferred NAD stabilisers are for example poly(hydroxystearic acid), and poly(hydroxystearic acid) graft (poly)methyl methacrylate and methacrylic acid copolymers, Solsperse 3000, Solsperse 11,200, Solsperse 13,300 and Solsperse 13,240 from Lubrizol Ltd., UK. Advantageously stabilisers comprising additionally copolymerised glycidyl methacrylate may be permanently locked in the polymer particle. This is simply done in the same vessel, by raising the temperature and adding diethanolamine. This opens up a glycidyl ring which is then available to polymerise with unreacted carboxylic acid groups from a methacrylic acid monomer.

Cross-linked copolymer nanoparticles can preferably be prepared by copolymerisation of methyl methacrylate (MMA), methacrylic acid, dye monomer, 1-octanethiol and NAD stabiliser using azobisisobutyronitrile (AIBN) or 2,2′-Azobis(2-methylbutyronitrile (Vazo 67) as an initiator. Preferably, polymerisations are conducted using a batch process. Especially, at least one dye according to Formula (1) is used, preferably at least one dye of Formulas (2) to (5). Most preferred are the polymerisable dyes listed in Table 1, especially Dye 1, Dye 2, and Dye3.

Electrowetting fluids of the invention may comprise one set of polymer particles wherein all particles have the same colour. However, for the fine colour tuning of electrowetting display colour states the fluid may comprise at least two sets of polymer particles having different colours. Mixing colour polymer particles instead of designing and mixing dyes has several advantages. By using dyes already available, colour polymer particles can be synthesised and mixed to obtain colour coordinates. Some colours are very difficult to realise with single dye chromophores—for example a pure jet black, or a good green. By mixing colour polymer particles, a more neutral black can be easily realised or improved colour. A greater range of colours can be achieved by mixing colour polymer particles.

The electrowetting fluids of the invention usually comprise a non-polar solvent or a mixture of non-polar solvents and are primarily designed for use as the non-polar phase in electrowetting display devices. So, further subjects of the invention are electrowetting display devices comprising such fluids.

A typical electrowetting display device preferably consists of the particles in a low polar or non-polar solvent along with additives to improve properties, such as stability and charge. The present electrowetting fluids comprising a non-polar (hydrophobic) solvent or solvent mixture and at least one dye according to the invention can be mixed with a clear colourless polar (hydrophilic) solvent, and the resultant biphasic mixture is placed on a suitable electrowetting surface, for example a highly hydrophobic dielectric layer. The wetting properties of the resultant biphasic mixture can then be modified by the presence of an electric field. This effect can be used to manipulate the position of a dyed fluid within a pixel. Examples of such solvents, additives for electrowetting fluids, and electrowetting display devices are described in the literature, for example in WO 2011/017446, WO 2010/104606, and WO 2011/075720.

A preferred non-polar solvent choice displays a low dielectric constant (<10, more preferably <5), high volume resistivity (about 10¹⁵ ohm-cm), low viscosity (less than 5 cst), low water solubility, a high boiling point (>80° C.) and a refractive index and density similar to that of the polar phase to be used. Tweaking these variables can be useful in order to change the behaviour of the final application. Preferred solvents are often non-polar hydrocarbon solvents such as the Isopar series (Exxon-Mobil), Norpar, Shell-Sol (Shell), Sol-Trol (Shell), naphtha, and other petroleum solvents, as well as long chain alkanes such as dodecane, tetradecane, decane, nonane or mixtures of these solvents. These tend to be low dielectric, low viscosity, and low density solvents. Especially preferred solvents according to the invention are long chain alkanes such as dodecane, tetradecane, decane, nonane or mixtures of these solvents.

Preferably, the electrowetting fluid comprises at least one surfactant. The role of the surfactant is to stabilize the dispersion. This may be achieved by using a blend of surfactants or one single surfactant. Surfactant examples are generally those with a hydrophilic head group and a hydrophobic tail. Typical surfactants are known to experts in the field of colloid science and include (but are not limited to) the Brij, Span and Tween series of surfactants (Aldrich), the Solsperse, Ircosperse and Colorburst series (Lubrizol).

The disclosures in the cited references are expressly also part of the disclosure content of the present patent application. In the claims and the description, the words “comprise/comprises/comprising” and “contain/contains/containing” mean that the listed components are included but that other components are not excluded. All process steps described above and below can be carried out using known techniques and standard equipments which are described in prior art and are well-known to the skilled person. The following examples explain the present invention in greater detail without restricting the scope of protection. In the foregoing and in the following examples, unless otherwise indicated all parts and percentages are by weight.

### EXAMPLES

The characterisation of the formulations is performed using a Malvern NanoZS particle analyser unless otherwise stated. This instrument measures the size of particles in dispersion and the zeta potential of an electrowetting fluid.

Span 85 is purchased from Fluka. Vazo 67 (2,2′-Azobis(2-methylbutyronitrile) is purchased from Du Pont. All other chemicals are purchased from Sigma-Aldrich. All chemicals are purchased at the highest grade possible and are used without further purification unless otherwise stated.

The following abbreviations are used:

IMS industrial methylated spirit;

### NMP N-Methylpyrrolidone

### THF Tetrahydrofuran

Mp melting point

### Example 1

### Preparation of 2,2′-(2-((4-(dioctylamino)-2-methylphenyl)-diazenyl)-5-((4-nitrophenyl)diazenyl)-1,4-phenylene)bis(oxy)bis(ethane-2,1-diyl)diacrylate

### Dye 1

Prepared by a 5 step procedure as detailed below:

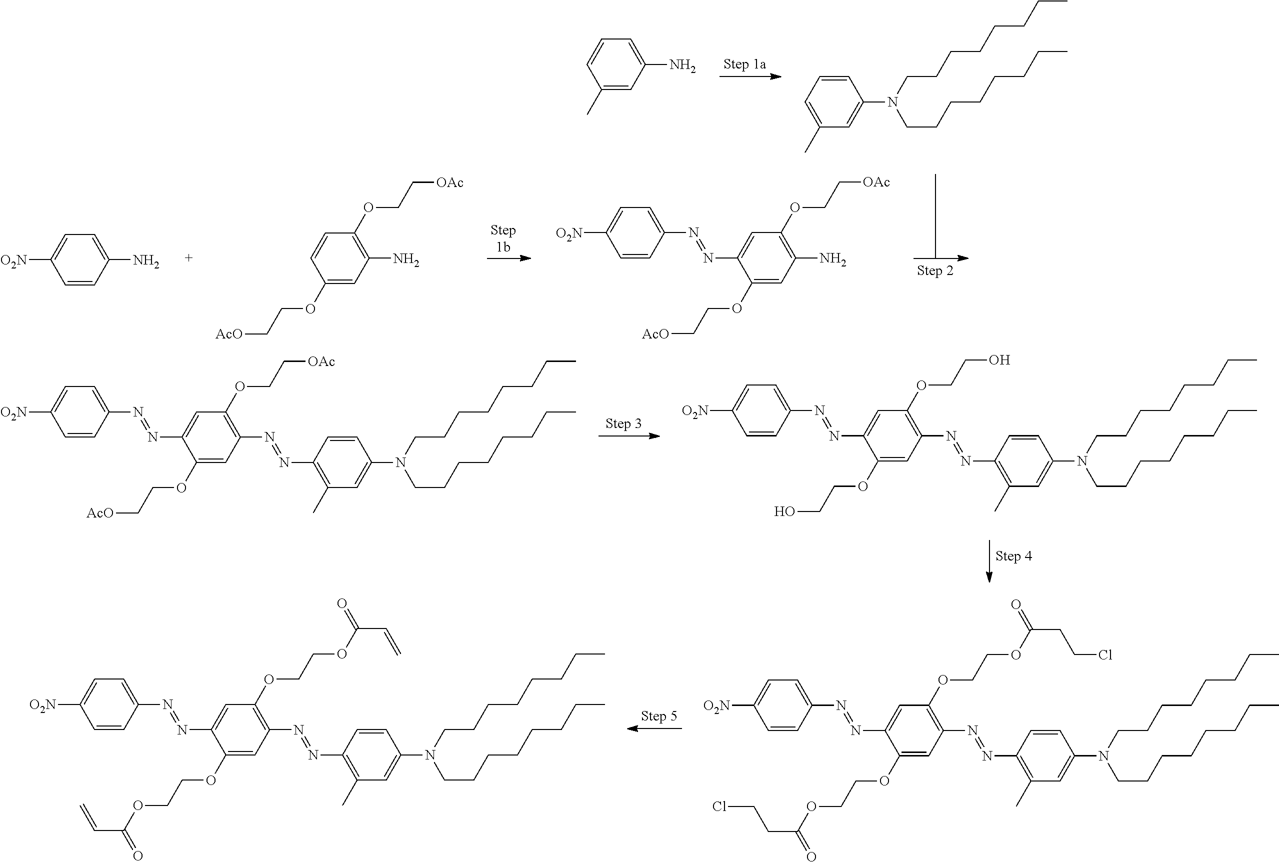

### Step 1a: 3-Methyl-N,N-dioctylaniline

m-Toluidine (26.75 g, 0.25 mol), water (30 ml), 1-bromooctane (144.9 g, 0.75 mol), and MgO (100.8 g, 2.5 mol) are charged to a flask and the resultant suspension is heated to 110° C. for 48 hours. The reaction mixture is allowed to cool and hexane is added, which causes precipitation of further solid. The solids are filtered-off to give an off-white filter cake and a yellow/brown filtrate. The filter cake is suspended in methylene chloride (100 ml), washed with dilute NaOH (3×100 ml), and dried over MgSO₄. The solution is filtered, then passed through a small pad of silica gel to give a pale yellow filtrate. Evaporation of solvent gives the product as a pale yellow free flowing oil (34.5 g, 42%). ¹H NMR showed expected signals.

### Step 1b: 2,2′-(2-Amino-5-((4-nitrophenyl)diazenyl)-1,4-phenylene)bis-(oxy)bis(ethane-2,1-diyl)diacetate

4-Nitroaniline (6.9 g, 0.05 mol) is suspended in dilute HCl and a solution of sodium nitrite (3.6 g, 0.053 mol) is added at 0-5° C., pH<1. Excess nitrous acid is destroyed by adding sulfamic acid and the solution is then added dropwise to solution of 2,2′-(2-amino-1,4-phenylene)bis(oxy)bis(ethane-2,1-diyl)diacetate in aqueous acetone. The resultant orange suspension is stirred overnight at ambient temperature before the solid is filtered-off, washing with water and industrial methylated spirits (IMS), then recrystallised from ethyl cellosolve, washing the isolated red solid with IMS and drying at 40° C. (16.0 g, 72%), mp=197-200° C. Structure is confirmed by ¹H NMR.

### Step 2: 2,2′-(2-((4-(dioctylamino)-2-methylphenyl)diazenyl)-5-((4-nitrophenyl)diazenyl)-1,4-phenylene)bis(oxy)bis(ethane-2,1-diyl)diacetate

2,2′-(2-Amino-5-((4-nitrophenyl)diazenyl)-1,4-phenylene)bis(oxy)bis(ethane-2,1-diyl)diacetate (4.5 g, 10 mmol) is stirred in N-methyl pyrrolidone (45 ml) and warmed to 60° C. to dissolve. The solution is then cooled with stirring to 5° C., giving a thick, fine precipitate. Nitrosylsulfuric acid (40% w/w) (3.2 g, 10 mmol) is added dropwise causing all solids to dissolve. The reaction is stirred for a further 1.5 hours, warming slowly to 40° C. 3-Methyl-N,N-dioctylaniline (3.3 g, 10 mmol) and sulfamic acid (0.5 g) are dissolved in a mixture of acetone and IMS and to this is added ice/water, causing a fine suspension to form. The prepared diazonium salt solution is then added and the mixture is stirred overnight, allowing it to warm to room temperature. The black solid is filtered-off and dried (6.4 g, 81%). The solid is not purified further at this stage.

### Step 3: 2,2′-(2-((4-(dioctylamino)-2-methylphenyl)diazenyl)-5-((4-nitrophenyl)diazenyl)-1,4-phenylene)bis(oxy)diethanol

2,2′-(2-((4-(Dioctylamino)-2-methylphenyl)diazenyl)-5-((4-nitrophenyl)diazenyl)-1,4-phenylene)bis(oxy)bis(ethane-2,1-diyl)diacetate (4.3 g, 5.5 mmol) is dissolved in tetrahydrofuran (100 ml), with stirring for 5 minutes, and to this is added 1N LiOH (25 ml, 25 mmol). The reaction is stirred at ambient temperature overnight. Acetic acid (5 ml) is added, followed by water (150 ml) which causes an oil to separate. After stirring for 1 h, the oil solidifies. The solid is filtered-off and washed with water (500 ml). The solid is crystallised from methylene chloride (200 ml) by addition of methanol (300 ml), and allowing overnight evaporation to a final volume of approximately 100 ml. The resultant black micro-crystalline solid is filtered-off and washed with methanol (30 ml). The solid is pulled dry under vacuum then dried for 2 hours in a desiccator (2.1 g, 54%). The material is used directly without further purification.

### Step 4: 2,2′-(2-((4-(dioctylamino)-2-methylphenyl)diazenyl)-5-((4-nitrophenyl)diazenyl)-1,4-phenylene)bis(oxy)bis(ethane-2,1-diyl)bis(3-chloropropanoate)

2,2′-(2-((4-(Dioctylamino)-2-methylphenyl)diazenyl)-5-((4-nitrophenyl)diazenyl)-1,4-phenylene)bis(oxy)diethanol (3.5 g, 5.0 mmol) is dissolved in methylene chloride (40 ml) with stirring for 5 minutes, and to this is added potassium carbonate (2.6 g, 18.8 mmol) followed by 3-chloropropionyl chloride (3.8 g, 30 mmol). The flask is equipped with an air condenser and the reaction warmed in an oil bath at 35° C. overnight, then for a further 72 hours at ambient temperature. Water (10 ml) and NaHCO₃ are added and the reaction stirred for 1 hour. The organic layer is separated, dried (MgSO₄) and evaporated. The crude product is purified over a short pad of silica gel, eluting initially with methylene chloride, which brings the bulk of the product through. The pad is then eluted with 10% acetone/methylene chloride, which elutes more of the required product and the lower running mono-ester. The later fraction is evaporated and re-purified over silica, eluting with methylene chloride until all of the required material is collected. The pure fractions are combined and evaporated to a black oil, which is solidified by triturating with methanol overnight. The solid is filtered-off and pulled dry to give a black solid. After drying overnight in a desiccator, a black powder is obtained (3.4 g, 77%).

### Step 5: 2,2′-(2-((4-(dioctylamino)-2-methylphenyl)diazenyl)-5-((4-nitrophenyl)diazenyl)-1,4-phenylene)bis(oxy)bis(ethane-2,1-diyl)diacrylate

### Dye 1

2,2′-(2-((4-(Dioctylamino)-2-methylphenyl)diazenyl)-5-((4-nitrophenyl)diazenyl)-1,4-phenylene)bis(oxy)bis(ethane-2,1-diyl)bis(3-chloropropanoate) (3.4 g, 3.8 mmol) and 2,6-di-t-butylphenol (5 mg) are dissolved in methylene chloride (20 ml) and triethylamine (1.16 g, 11.5 mmol) is added. The reaction is shaken to mix, then stored in the dark in a cupboard overnight. The reaction is washed with 0.01 M HCl (20 ml), dried and evaporated. The residue is re-dissolved in methylene chloride (10 ml) and methanol (50 ml) is slowly added with stirring. The precipitated dye is filtered-off, washed with methanol and dried overnight in a desiccator to a fine black powder (3.0 g, 97%). λₘₐₓ (EtOAc) 565 nm (43,400), FWHM 142 nm. HPLC: 100% (550 nm).

### Example 2

### Preparation of 2,2′-(2-(-(4-(Dioctylamino)-2-methylphenyl)-diazenyl)-5-((4-nitrophenyldiazenyl)-1,4-phenylene)bis(oxy)bis(ethane-2,1-diyl)diacrylate

### Dye 2

Prepared by a 4 step procedure as detailed below:

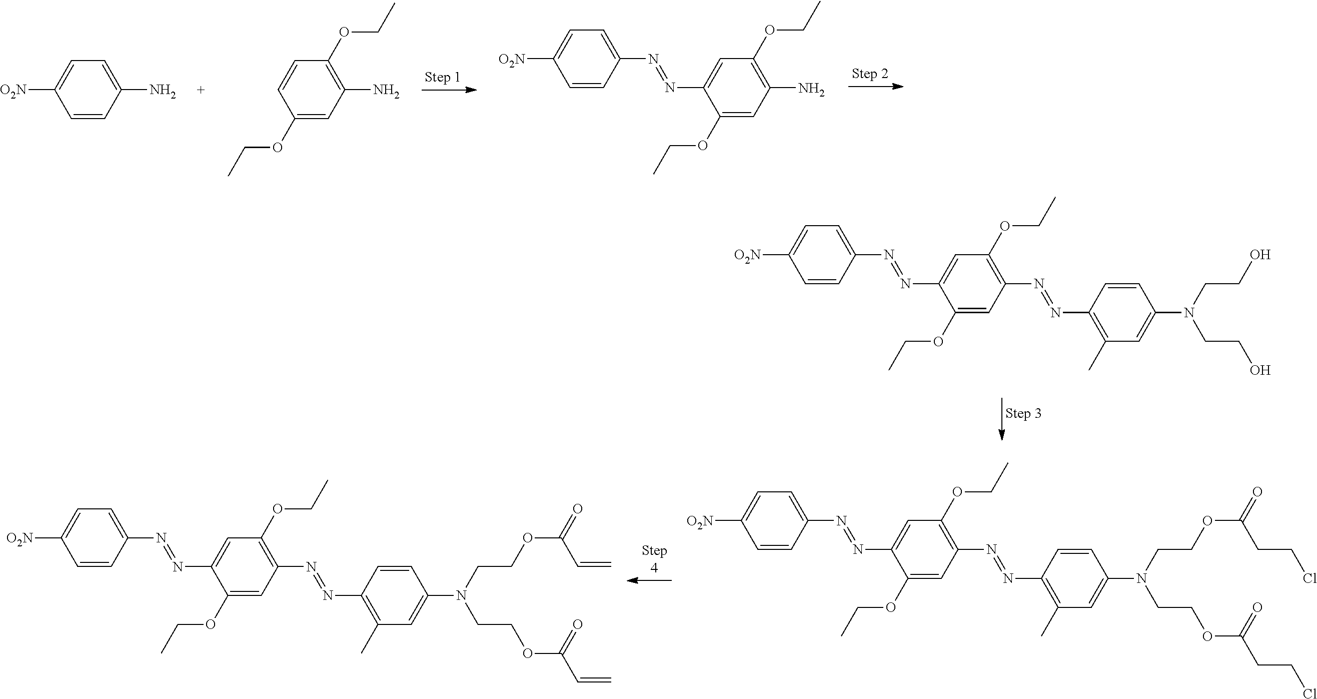 [SMILES: Nc1ccc([N+](=O)[O-])cc1 ; CCOc1ccc(OCC)c(N)c1 ; CCOc1cc(/N=N/c2ccc([N+](=O)[O-])cc2)c(OCC)cc1N ; CCOc1cc(/N=N/c2ccc(N(CCO)CCO)cc2C)c(OCC)cc1/N=N/c1ccc([N+](=O)[O-])cc1 ; C=CC(=O)OCCN(CCOC(=O)C=C)c1ccc(/N=N/c2cc(OCC)c(/N=N/c3ccc([N+](=O)[O-])cc3)cc2OCC)c(C)c1 ; CCOc1cc(/N=N/c2ccc(N(CCOC(=O)CCCl)CCOC(=O)CCCl)cc2C)c(OCC)cc1/N=N/c1ccc([N+](=O)[O-])cc1]

### Step 1: 2,5-Diethoxy-4-((4-nitrophenyl)diazenyl)aniline

4-Nitroaniline (6.9 g, 0.05 mol) is suspended in water (150 ml) and 35% HCl (17.3 g) is added. To this is added a solution of sodium nitrite (3.6 g, 0.053 mol) at 0-5° C., pH<1. Once all solid has dissolved, excess nitrous acid is destroyed by addition of sulfamic acid and the solution is then added dropwise to a solution of 2,5-diethoxyaniline (9.4 g, 0.052 mol) in water (300 ml) and 35% HCl

(6 g). The resultant suspension is stirred overnight, filtered-off, washed copiously with cold water, then crystallised from ethyl cellosolve (400 ml). The resulting solid is filtered-off, washed with IMS and dried to a fine red crystalline solid (15.4 g, 93%). Mp=218-220° C.

### Step 2: 2,2′-(4-((2,5-diethoxy-4-((4-nitrophenyl)diazenyl)phenyl)diazenyl)-3-methylphenylazanediyl)diethanol

2,5-Diethoxy-4-((4-nitrophenyl)diazenyl)aniline (3.3 g, 10 mmol) is stirred in NMP (45 ml) and warmed to 60° C. to dissolve. The solution is then cooled with stirring to 5° C., giving a thick fine precipitate. Ntrosylsulfuric acid (40% w/w) (3.2 g, 10 mmol) is added. The solution is stirred for a further 2 hours at room temperature. N,N-dihydroxyethyl-m-toluidine (1.95 g, 10 mmol) and sulfamic acid (0.5 g) are dissolved in a mixture of butanol/water, and the prepared diazonium salt solution is then added. The mixture is stirred overnight, allowing it to warm to room temperature. The black solid is filtered-off and dried (4.6 g, 85%). The solid is purified further by dissolution in ethyl cellosolve (200 ml) at 100° C., followed by dropwise addition of water (100 ml). On cooling, a precipitate is formed, which is filtered-off, washed with water, IMS and dried to give a fine blue-black solid (2.9 g, 54%).

### Step 3: 2,2′-(4-((2,5-diethoxy-4-((4-nitrophenyl)diazenyl)phenyl)diazenyl)-3-methylphenylazanediyl)bis(ethane-2,1-diyl)bis(3-chloropropanoate)

2,2′-(4-((2,5-Diethoxy-4-((4-nitrophenyl)diazenyl)phenyl)diazenyl)-3-methylphenylazanediyl)diethanol (2.9 g, 5.4 mmol) and K₂CO₃ (2.8 g, 20 mmol) are suspended in THF (85 ml) and 3-chloropropionyl chloride (2.5 g, 20 mmol) is added. After stirring at ambient temperature for 24 hours, water (5 ml) is added, stirring continues for 30 minutes. The residue is dissolved in methylene chloride and filtered through a small pad of silica gel. The filtrate is evaporated and the residue is crystallised from a mixture of methylene chloride and IMS. The resultant black crystals are filtered-off, washed with IMS and dried (1.6 g, 41%). A second crop of tarry black crystals are isolated (1.7 g, 44%).

### Step 4: 2,2′-(4-((2,5-diethoxy-4-((4-nitrophenyl)diazenyl)phenyl)diazenyl)-3-methylphenylazanediyl)bis(ethane-2,1-diyl)diacrylate

### Dye 2

2,2′-(4-((2,5-Diethoxy-4-((4-nitrophenyl)diazenyl)phenyl)diazenyl)-3-methylphenylazanediyl)bis(ethane-2,1-diyl)bis(3-chloropropanoate) (3.3 g, 4.6 mmol) is dissolved in methylene chloride (40 ml) and triethylamine (1.0 g, 10.1 mmol) is added. Methanol (50 ml) is slowly added with stirring and the product is crystallised from solution (2.4 g, 81%).

The crude material is purified over silica gel, eluting with toluene/methylene chloride. Fractions enriched with the required product are pooled, evaporated and dried in a vacuum desiccator (0.87 g, 29%). The material contains <3 mol % impurity by ¹H NMR. λₘₐₓ (EtOAc) 544 nm (35,500), half bandwidth 152 nm (605-453 nm).

### Example 3

### Preparation of

### Dye 3

Prepared by a 7 step procedure as detailed below:

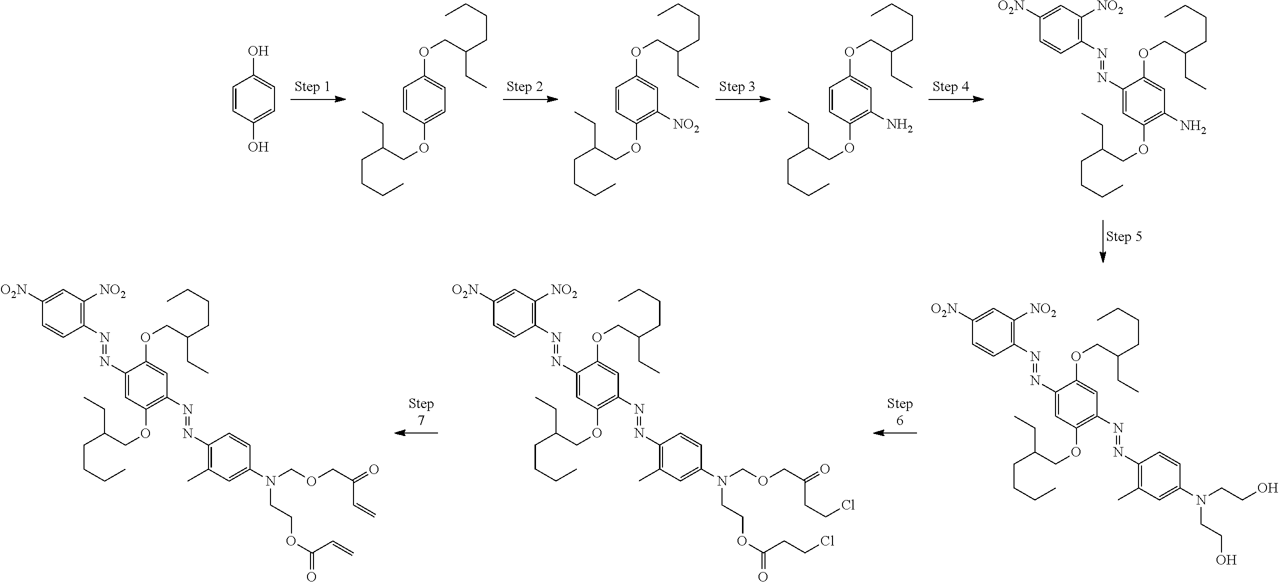

### Step 1: 1,4-Bis(2-ethylhexyloxy)benzene

Hydroquinone (37.9 g, 0.344 mol) is suspended in IMS (310 ml) and 1-bromo-2-ethylhexane (132.7 g, 0.687 mol) is added. A solution of KOH (49.9 g, 0.89 mol) in IMS (250 ml) is added slowly over 1 minute. The mixture is heated at reflux whilst monitoring reaction progress by HPLC. After 16 hours, further 1-bromo-2-ethylhexane (53.1 g, 0.27 mol) and solid KOH (20.0 g, 0.36 mol) are added then heated for 2 hours at reflux. The reaction mixture is allowed to cool, is poured into water (1.5 L) and extracted with toluene (500 ml). The organic layer is dried over MgSO₄ then evaporated to yield a pale yellow oil. The oil is flashed through silica gel, eluting with 50/50 dichloromethane/hexane to give two product fractions. The initial fraction (35.3 g) co-eluted with 2-ethylhexan-1-ol by-product. The second fraction is evaporated to give pure 1,4-bis(2-ethylhexyloxy)benzene as a pale yellow oil (48.4 g, 42%). The initial fraction is further purified by bulb to bulb distillation to give further pure 1,4-bis(2-ethylhexyloxy)benzene as a pale yellow oil (25.3 g, 22%).

### Step 2: 1,4-Bis(2-ethylhexyloxy)-2-nitrobenzene

1,4-Bis(2-ethylhexyloxy)benzene (50.2 g, 0.150 mol) is dissolved in chloroform (150 ml) and cooled to 0° C. Nitric acid (70%, 17.0 g, 0.190 mol) is added dropwise at 0-3° C. and the reaction stirred whilst monitoring progress by HPLC. After 60 minutes, water (50 ml) is added and the organic layer separated, dried (MgSO₄) and evaporated to give the title compound as a yellow oil (56.9 g, 100%). The material is used without further purification.

### Step 3: 2,5-Bis(2-ethylhexyloxy)aniline

1,4-Bis(2-ethylhexyloxy)-2-nitrobenzene (11.4 g, 0.03 mol) is dissolved in 2-propanol (100 ml) and degassed under vacuum, purging to nitrogen. 10% (w/w) Pd/C (0.52 g) is added and the mixture heated to 80° C. Water (10 ml) is added, followed by solid ammonium formate (18.9 g, 0.3 mol). After a further 1 hour at 80° C., the reaction mixture is allowed to cool then filtered to remove catalyst, to give a colourless solution which darkened rapidly on standing. The material is used immediately as an isopropanol solution (quant.).

### Step 4: 4-((2,4-Dinitrophenyl)diazenyl)-2,5-bis(2-ethylhexyloxy)aniline

2,4-Dinitroaniline (3.7 g, 0.02 mol) is suspended in a mixture of acetic acid (20 ml) and propionic acid (10 ml) and cooled to 3° C. 40% (w/w) nitrosyl sulfuric acid in sulfuric acid (6.4 g, 0.02 mol) is added dropwise and stirring continued for 30 minutes to give a pale yellow solution. Crude 2,5-bis(2-ethylhexyloxy)aniline (0.02 mol) solution is diluted with IMS (200 ml) and 10% sulfamic acid solution (20 ml) added, followed by ice (200 g). The above pale yellow diazonium salt solution is slowly added with stirring and a dark oil rapidly separated. The mixture is stirred overnight and the water is decanted off. The crude product (8.3 g) is dissolved in 25/75 dichloromethane/hexane and purified over silica gel, the required product eluting with 50/50 hexane/dichloromethane. Evaporation and trituration with methanol gave 4-((2,4-dinitrophenyl)diazenyl)-2,5-bis(2-ethylhexyloxy)aniline as a violet-blue crystalline solid (4.2 g, 39%).

### Step 5: 2,2′-(4-((E)-(4-((E)-(2,4-Dinitrophenyl)diazenyl)-2,5-bis(2-ethylhexyloxy)phenyl)diazenyl)-3-methylphenylazanediyl)diethanol

4-((2,4-Dinitrophenyl)diazenyl)-2,5-bis(2-ethylhexyloxy)aniline (0.54 g, 1 mmol) is dissolved in NMP (10 ml) and to this is added 40% (w/w) nitrosyl sulfuric acid in sulfuric acid (0.38 g, 1.2 mmol). After 30 minutes, the mixture is added to a solution of 2,2′-(m-tolylazanediyl)diethanol (0.20 g, 1 mmol) and sulfamic acid (0.5 g) in IMS (100 ml). A dark oily solid separates immediately. After stirring overnight, the aqueous supernatant is decanted off, the oily solid washed with further water, then dried at 40° C. The pure title compound is acquired as a blue-black solid after multiple purifications over silica gel, eluting with dichloromethane containing an increasing concentration of ethyl acetate (0.54 g, 72%).

### Step 6: 2,2′-(4-((E)-(4-((E)-(2,4-dinitrophenyl)diazenyl)-2,5-bis(2-ethylhexyloxy)phenyl)diazenyl)-3-methylphenylazanediyl)bis(ethane-2,1-diyl)bis(3-chloropropanoate)

2,2′-(4-((E)-(4-((E)-(2,4-Dinitrophenyl)diazenyl)-2,5-bis(2-ethylhexyloxy)phenyl)diazenyl)-3-methylphenylazanediyl)diethanol (3.5 g, 5 mmol) is dissolved in dichloromethane (50 ml) and sodium bicarbonate (12.6 g, 0.15 mol) is added with stirring to suspend. 3-Chloropropionyl chloride (1.9 g, 15 mmol) is added and the mixture heated at 40° C. (bath temp.) overnight. The inorganics are filtered off, the dichloromethane is evaporated and the product solidified by adding IMS. A 2.7 g sample of crude product is taken through directly to the next step without further purification. A 1 g sample of material is recrystallised from IMS to obtain a pure sample as a violet/black crystalline solid; m.p 123-125° C., λₘₐₓ (EtOAc) 573 nm (40,000), half bandwidth 160 nm, 353 nm (13,500).

### Step 7: 2,2′-(4-((E)-(4-((E)-(2,4-dinitrophenyl)diazenyl)-2,5-bis(2-ethylhexyloxy)phenyl)diazenyl)-3-methylphenylazanediyl)bis(ethane-2,1-diyl)diacrylate

Crude 2,2′-(4-((E)-(4-((E)-(2,4-dinitrophenyl)diazenyl)-2,5-bis(2-ethylhexyloxy)phenyl)diazenyl)-3-methylphenylazanediyl)bis(ethane-2,1-diyl)bis(3-chloropropanoate) (2.7 g, 2.9 mmol) is dissolved in dichloromethane (50 ml) and triethylamine (0.9 g, 8.7 mmol) is added. The mixture is heated at 30° C. (bath temp.) overnight and the product precipitated by adding IMS. The solid is recrystallised from hot IMS and the title compound is isolated as a violet/black powder; m.p 128-130° C., λₘₐₓ (EtOAc) 574 nm (40,000), half bandwidth 160 nm, 354 nm (13,500).

### Examples 4-6

### Preparation of Black Polymer Particles

### Example 4

### Preparation of Dyed Polymer Particles Incorporating Black Polymerisable Dyes at 5 Weight % Based on Methyl Methacrylate by Dispersion Polymerisation and Exemplified for the Black Polymerisable

### Dye 1 of Example 1

NAD stabiliser 30% by weight in dodecane is obtained from ICI Ltd. precipitated in cold methanol, dried and dissolved in a 50:50 mixture of ethyl acetate (Aldrich) and butyl acetate (Aldrich). All materials other than dyes are commercially available.

Methyl methacrylate (20.58 g), NAD stabiliser (3.50 g) and methacrylic acid (0.42 ml) are weighed out into a 100 ml 3-necked flask equipped with a condenser, nitrogen flow, and an overhead stirrer. Dye 1 (1.029 g, 5 weight %) is added and stirred for 1 minute to facilitate dissolution of the dye. Dodecane (25.20 g) is added to the reaction flask, followed by 1-octanethiol (0.125 ml).

The mixture is heated with stirring at 300 rpm, once the temperature in the flask is at 75° C., Vazo 67 (0.20 g) is added and the reaction is stirred for 2 hours. The resulting solution is filtered through 50 micron cloth to remove small lumps. The particles are cleaned using a centrifuge. Centrifugations are carried out at 10 000 rpm for 40 minutes each, replacing the supernatant with dodecane, this is repeated until the supernatant is colourless. Average particle size is measured by SEM and image analysis: 234 nm.

Table 2 shows similarly prepared polymer particles containing the following dyes (the weight % of dyes based on methyl methacrylate; size measured by SEM):

TABLE 2

| Example | | | Size/ |
|---|---|---|---|
| Number | Dye Name | Dye % | nm |
| 4 | Dye 1 | 5 | 234 |
| 5 | Dye 2 | 5 | 169 |
| 6 | Dye 3 | 5 | 547 |

### Example 7

### Preparation of Black Polymer Particles Dispersed in Decane for Electrowetting

0.1067 g of Black polymer particles from example 6 and 0.0513 g of Solsperse 3000 are added to 0.8805 g of Dodecane and left to equilibrate on a roller mixer for 24 hours.

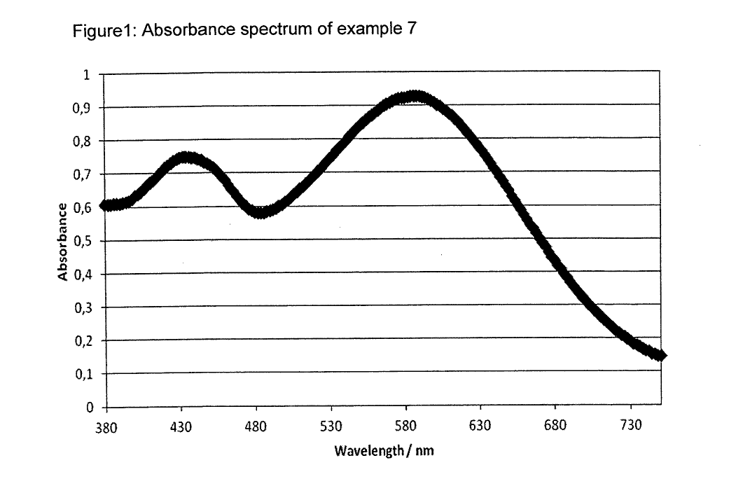

The resultant dispersion was analysed by uv-vis spectrophotometry to obtain an absorbance spectrum as shown in FIG. 1. An average absorbance of 0.631 was measured in a 50 micron cell. The Density, Viscosity and Surface Tension were measured by standard methods and are shown in table 3.

TABLE 3

| Parameter | Value |
|---|---|
| Density g/cm3 | 0.8 |
| Viscosity cP | 2.1 |
| Surface Tension mN/m | 22.5 |

1-16. (canceled)

17. An electrowetting fluid comprising polymer particles comprising monomer units of a) at least one polymerisable dye, b) at least one monomer, c) optionally at least one charged co-monomer, and d) optionally at least one crosslinking co-monomer.

18. The electrowetting fluid according to claim 17, wherein the polymerisable dye comprises a chromophore, at least two polymerisable groups, optional linker groups (spacers), and optional groups to modify physical properties (like solubility, light fastness, etc.) and optionally charged group(s).

19. The electrowetting fluid according to claim 17, wherein the polymerisable dye is a dye of Formula (1) 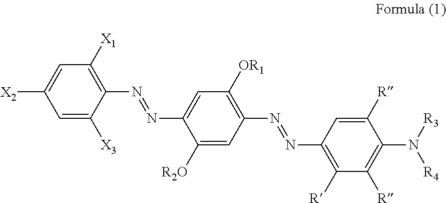
wherein
X₁, X₂, and X₃ are independently of one another H or an electron-withdrawing group;
R₁ and R₂ are independently of one another groups of the structure L₁-Y₁, L₂-Y₂ or linear, branched or cyclic alkyl groups;
R₃ and R₄ are independently of one another groups of the structure L₃-Y₃, L₄-Y₄ or linear, branched or cyclic, substituted or unsubstituted alkyl groups where one or more non-adjacent carbon atoms may be replaced by O, S and/or N;
L₁, L₂, L₃, and L₄ are independently of one another linear or branched, substituted or unsubstituted alkylene groups where one or more non-adjacent carbon atoms may be replaced by O, S and/or N;
Y₁, Y₂, Y₃, and Y₄ are independently of one another polymerisable groups;
R′ is a linear or branched alkyl group, OR₅, H, NHCOR₆ or NHSO₂R₇;
R″ is OR₅, H or NHCOR₆,
R₅, R₆, and R₇ are independently of one another linear or branched alkyl groups; and
wherein at least one of R₁, R₂, R₃ and R₄ is a polymerisable group and at least one of X₁, X₂, and X₃ is an electron-withdrawing group.

20. The electrowetting fluid according to claim 19, wherein at least two of Y₁, Y₂, Y₃, and Y₄ are polymerisable groups selected from acrylate and methacrylate groups.

21. The electrowetting fluid according to claim 19, wherein X₂ is or X₂ and one of X₁ and X₃ are NO₂, CN, Br, Cl, SO₂NRR or SO₂NHR, with R=C1-C4 alkyl.

22. The electrowetting fluid according to claim 19, wherein groups R₁, R₂ R₃, and R₄ are, independently of one another linear, branched or cyclic alkyl groups having 1 to 10 C atoms.

23. The electrowetting fluid according to claim 19, wherein groups L₁-Y₁, L₂-Y₂, L₃-Y₃ or L₄-Y₄ L₁, L₂, L₃, and L₄ denote independently of one another linear or branched alkylene groups having 1 to 10 C atoms and Y₁, Y₂, Y₃, and Y₄ denote independently of one another methacrylate or acrylate.

24. The electrowetting fluid according to claim 19, wherein R′ is CH₃ or OCH₃ and R″ is H.

25. The electrowetting fluid according to claim 17, wherein at least one dye of Formulas (2) to (5) is used 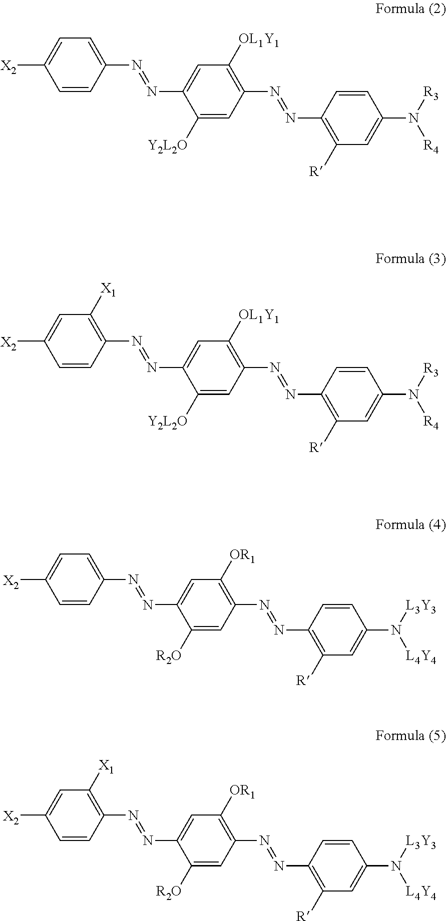
wherein
X₁ stands for NO₂ or CN;
X₂ stands for NO₂, CN Or halogen;
L₁, L₂, L₃, and L₄ stand for C2-C10 alkylene;
Y₁, Y₂, Y₃, and Y₄ stand for methacrylate or acrylate;
R₁, R₂, R₃, and R₄ stand for C2-C10 alkyl, and
R′ stands for CH₃ or OCH₃.

26. The electrowetting fluid according to claim 17, wherein at least one black polymerisable dye is used.

27. The electrowetting fluid according to claim 17, wherein the polymer particles have a diameter of 100-1000 nm.

28. The electrowetting fluid according to claim 17, wherein the polymer particles have a diameter of 150-600 nm.

29. A process for the preparation of polymer particles which comprises utilizing the formula 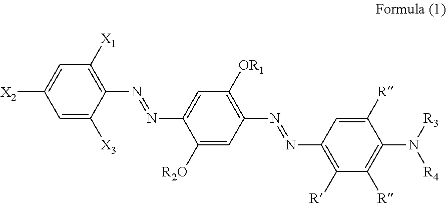
wherein
X₁, X₂, and X₃ are independently of one another H or an electron-withdrawing group;
R₁ and R₂ are independently of one another groups of the structure L₁-Y₁, L₂-Y₂ or linear, branched or cyclic alkyl groups;
R₃ and R₄ are independently of one another groups of the structure L₃-Y₃, L₄-Y₄ or linear, branched or cyclic, substituted or unsubstituted alkyl groups where one or more non-adjacent carbon atoms may be replaced by O, S and/or N;
L₁, L₂, L₃, and L₄ are independently of one another linear or branched, substituted or unsubstituted alkylene groups where one or more non-adjacent carbon atoms may be replaced by O, S and/or N;
Y₁, Y₂, Y₃, and Y₄ are independently of one another polymerisable groups;
R′ is a linear or branched alkyl group, OR₅, H, NHCOR₆ or NHSO₂R₇;
R″ is OR₅, H or NHCOR₆,
R₅, R₆, and R₇ are independently of one another linear or branched alkyl groups; and
wherein at least one of R₁, R₂, R₃ and R₄ is a polymerisable group and at least one of X₁, X₂, and X₃ is an electron-withdrawing group.

30. The process according to claim 29 wherein the dyes correspond to Formulas (2) to (5) 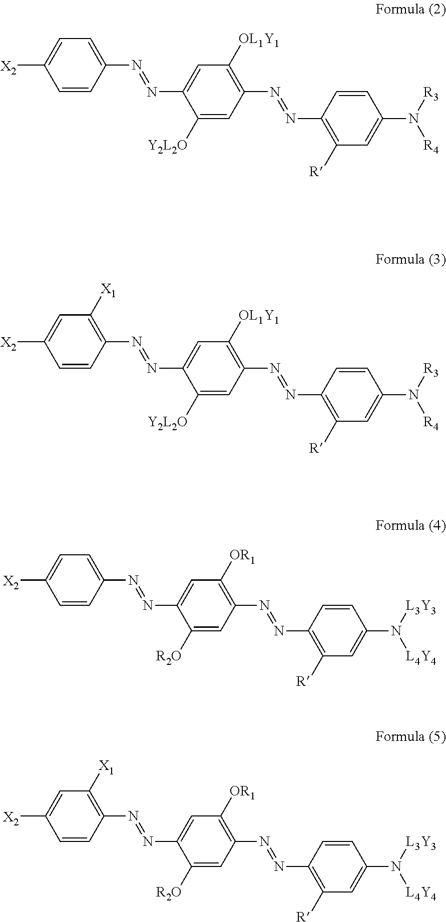
Wherein
X₁ stands for NO₂ or CN;
X₂ stands for NO₂, CN or halogen;
L₁, L₂, L₃, and L₄ stand for C2-C10 alkylene;
Y₁, Y₂, Y₃, and Y₄ stand for methacrylate or acrylate;
R₁, R₂, R₃, and R₄ stand for C2-C10 alkyl, and
R′ stands for CH₃ or OCH₃.

31. A process for the preparation of mono, bi or polychromal electrowetting fluids which comprises utilizing polymer particles comprising monomer units of a) at least one polymerisable dye, b) at least one monomer, c) optionally at least one charged co-monomer, and d) optionally at least one crosslinking co-monomer.

32. An electrowetting display device comprising an electrowetting fluid according to claim 17.

33. The electrowetting display device according to claim 31, wherein the electrowetting fluid is applied by a technique selected from inkjet printing, slot die spraying, nozzle spraying, and flexographic printing, or any other contact or contactless printing or deposition technique.
